(19) United States
(12) Patent Application Publication
(10) Pub. No.: US 2015/0014984 A1
(43) Pub. Date: Jan. 15, 2015

(54) UNIQUE IDENTIFIER AND HIGH SECURITY DEVICE RELATED TO SAID UNIQUE IDENTIFIER

(71) Applicant: SICPA HOLDING SA, Prilly (CH)

(72) Inventors: Eric DECOUX, Vevey (CH); Tristan JAUZEIN, Lausanne (CH)

(21) Appl. No.: 14/327,016

(22) Filed: Jul. 9, 2014

Related U.S. Application Data
(60) Provisional application No. 61/844,695, filed on Jul. 10, 2013.

(30) Foreign Application Priority Data
Jul. 19, 2013 (EP) PCT/EP2013/065333

(51) Int. Cl. B42D 25/36; B42D 25/47; B42D 25/405

(52) U.S. Cl. CPC B42D 25/36; B42D 25/405; B42D 25/47
USPC 283/81; 428/189; 156/277

(57) ABSTRACT

Marking of a substrate, comprising a mono-dimensional and/or bidimensional code and a distribution of flakes, the flakes being the same or different, the distribution of flakes at least partially overlapping the mono-dimensional and/or bidimensional code. Also, provided are items or goods including one or more markings, methods of making the marking and methods of using the marking as well as container including the markings.

### CROSS-REFERENCE TO RELATED APPLICATIONS

This application claims the benefit of U.S. Provisional Application No. 61/844,695, filed Jul. 10, 2013, and of PCT Application No. PCT/EP2013/065333, filed Jul. 19, 2013, the disclosures of which are incorporated by reference herein in their entireties.

### BACKGROUND OF THE INVENTION

1. Field of the Invention

The invention is in the field of marking and identifying an item or good. It concerns a method for providing an item or good with a unique marking. The invention also relates to identifying and/or tracking items and/or authenticating items, such as items of value. The invention also relates to the field of security as well as to valuable items or goods, such as a unique tamper evident structure with a marking, such unique marking and may be used in the prevention of counterfeiting.

2. Discussion of Background Information

Counterfeiting is no longer a national or a regional problem but a worldwide problem which has an impact not only on manufacturers but also on the consumer. Counterfeiting is a significant problem with goods like clothes and watches but becomes even more serious when it affects medicines and drugs. Each year thousands of people around the world die because of counterfeit drugs. Counterfeiting has also an impact on government revenues in that it affects the collection of taxes for, e.g., cigarettes and alcohol because of the existence of a black market where it is impossible to track and trace counterfeit (smuggled, diverted, etc.) products with no valid tax stamps.

Many solutions have been proposed to make counterfeiting impossible or at least very difficult and/or costly, for example RFID solutions and the use of invisible inks or mono dimensional code or bidimensional code as unique identifier to avoid or at least to limit drastically the existence of fake, diversion and/or counterfeit. Despite the fact that these solutions are useful, it remains that counterfeiters have now access to also many advanced technologies that allows them to reproduce or to mimic existing security device which sometimes are presented as unique identifier.

Another solution which also exist in the field of packaging or as a protection for items or goods and mainly used for pharmaceuticals packaging is tamper evident structure or void tamper security evident structure which in themselves are not a unique identifier, but a proof when these structures have been altered that a manipulation of packaging or items or good have occurred. Despite its strong interest to see whether or not a packaging has been subject of wrong manipulation, the main weaknesses of these structure, is that it could be reproduced (even if it remains difficult) but mainly its lack of uniqueness and its ability to deliver track and trace information.

There is then a crucial need, to improve the security and avoid fake, diversion or counterfeiting of goods, items or packaging containing valuable product, which must be fulfilled. But also there is a crucial need to protect consumers not only for having genuine products, but very often as it could happen in some developing countries saving people from death because of using fake medicines. There is then a crucial need to be fulfilled to provide unique identifier useful for authentication, able to provide track and trace information or identification which remains robust and having tamperproof properties.

### SUMMARY OF THE INVENTION

In accordance with non-limiting embodiments, there is provided a marking that includes a self-adhesive label associated therewith so that removal and replacement of the self-adhesive label leads to variation of a pattern so that tampering of the marking is evident.

The marking of an item or good, comprises, indicia, preferably a code, preferably a mono-dimensional and/or bidimensional code, and a distribution of flakes, the flakes being the same or different the distribution of flakes at least partially overlapping the indicia, such as a code, such as a mono-dimensional and/or bidimensional code.

There is also provided an item or good containing a marking, wherein the item or good is selected from a seal, a capsule or a cork, packaging, a cartridge, a container that contains nutraceuticals, pharmaceuticals, foodstuffs or beverages, a banknote, a credit card, a stamp, a tax label, a security document, a passport, an identity card, a driver's license, an access card, a transportation ticket, an event ticket, a voucher, an ink-transfer film, a reflective film, an aluminum foil, a cigarette packaging and a commercial good.

There is also provided the use of a marking for authenticating or identifying or tracking and tracing the item or good.

There is also provided a method of providing a marking on an item or good, wherein the method comprises:

a) printing or applying onto a surface of an item or good, an indicia, such as a code, such as a mono-dimensional and/or bidimensional code;
b) associating with the indicia, such as by applying onto at least a part of the indicia, preferably a mono-dimensional and/or bidimensional code, a distribution of flakes, the flakes being the same or different.

There is also provided an item or good that is obtainable by the methods disclosed herein.

There is also provided a container of at least one pharmaceutical or item of value such as watch or luxury product such as a jewel or jewelry, obtainable by the method disclosed herein.

There is also provided a marking of a substrate, comprising a code; a distribution of flakes, the flakes being the same or different; and a self-adhesive label; the distribution of flakes being at least one of (i) between the code and the self-adhesive label, (ii) a layer of the self-adhesive label; and (iii) above the self adhesive-label.

There is also provided an auto-adhesive marking member comprising, in the following order and in at least a partially overlapping relationship:

(a) a layer comprising a label stock layer or a self-adhesive label;

(b) a modifying resin layer; and

(c) a chiral liquid crystal polymer (CLCP) layer, the modifying resin layer being able to change the position of the selective reflection band exhibited by the CLCP layer, and

an optional separate layer, when present, being located between the layer comprising a label stock layer or a self-adhesive label and the modifying resin layer and/or the modifying resin layer and the CLCP layer; and

a distribution of flakes being present in (i) the modifying resin layer and/or (ii) the separate layer; and the flakes being the same or different.

There is also provided an item or good comprising a marking that is obtained by any of the method disclosed herein.

There is also provided a container of at least one pharmaceutical or item of value such as watch or luxury product, such as jewel, comprising a marking obtainable by an method disclosed herein.

There is also provided a method of forming a marking on a substrate comprising attaching the marking member, as disclosed herein, at least partially over a code on a substrate.

There is also provided a method of providing the marking as disclosed herein on a substrate comprising printing or applying onto a surface of a substrate, a code; applying onto at least a part of the code, one or more distribution of flakes layers and an auto-adhesive label; and the relationship of the one or more distribution of flakes layers and the auto-adhesive label being such that the one or more distribution of flakes layers comprises one or more of (i) a distribution of flakes layer between the code and the auto-adhesive label, (ii) a distribution of flakes in the auto-adhesive label, and (iii) a distribution of flakes above the auto-adhesive label.

There is also provided a method of forming a marking on a substrate comprising applying a distribution of flakes a least partially over a code on a substrate, and attaching the marking member disclosed herein at least partially over the distribution of flakes and the code.

There is also provides an auto-adhesive marking member comprising, in the following order and in at least a partially overlapping relationship:

(a) a layer comprising a label stock layer or a self-adhesive label;

(b) a functionalized modifying resin layer having associated therewith a distribution of flakes;

(c) a chiral liquid crystal polymer (CLCP) layer, the modifying resin layer being able to change the position of the selective reflection band exhibited by the CLCP layer.

The distribution of flakes can be present in (i) the functionalized modifying resin layer and/or (ii) at least one separate layer, the at least one separate layer can be located between the layer comprising a label stock layer or a self-adhesive label and the functionalized modifying resin layer and/or the functionalized modifying resin layer and the CLCP layer.

The distribution of flakes can be present in the modifying resin layer.

When the separate layer is present, the distribution of flakes can be at least present in the separate layer. Moreover, the distribution of flakes can also be included in the modifying resin layer.

The separate layer can be located between the layer comprising a label stock layer or a self-adhesive label and the modifying resin layer.

The distribution of flakes can comprise the same flakes in the separate layer and the modifying resin layer.

The distribution of flakes can comprise different sizes of flakes in the separate layer and the modifying resin layer.

The distribution of flakes can comprise flakes having different detectable properties in the separate layer and the modifying rein layer.

The code can be selected from mono-dimensional and/or bidimensional code.

The self-adhesive label can be between the mono-dimensional and/or bidimensional code and the distribution of flakes.

A modifying resin layer can be above the distribution of flakes, a chiral liquid crystal polymer (CLCP) layer can be above the modifying resin layer, and the modifying resin layer can be able to change the position of the selective reflection band exhibited by the CLCP layer.

The distribution of flakes and the self-adhesive label can be adjacent layers.

The self-adhesive label can be above the distribution of flakes.

The distribution of flakes and the self-adhesive label can be adjacent layers.

The distribution of flakes can comprise a layer of the self-adhesive label.

There can be at least two distributions of flakes layers, one of the two distributions of flakes layers can be between the mono-dimensional and/or bidimensional code and the self-adhesive label and the other of the two distributions of flakers can be above the self-adhesive label.

The at least two distribution flakes layers can also comprise a layer of the self-adhesive label.

The code can further comprise, invisible to the unaided eyes, a layer with secure and/or authentication and/or track and trace properties, glyph, encoded data invisible to the unaided eyes, watermark data, encrypted data with private and/or public key, taggant and/or dyes and/or pigments which have luminescent and/or magnetic properties invisible to the unaided eye.

At least part of the flakes can be chiral liquid crystal polymer (CLCP) flakes having at least one layer of CLCP.

The CLCP flakes can further comprise an additional layer made with luminescent and/or magnetic material.

The CLCP flakes can be visible and/or invisible to the unaided eyes.

The distribution of flakes can comprise at least two different sizes of flakes and/or two different aspect ratios of flakes.

The position of a selective reflection band exhibited by the flakes can be the same or different.

The position of a selective reflection band exhibited by said flakes can be comprised between 400 to 1200 nm.

The flakes can be distributed randomly.

The flakes have the same or different circular polarization properties.

The flakes at least partially overlapping said mono-dimensional and/or bidimensional code can be dispersed in a binder.

The binder can be a resin which is able to change the position of the selective reflection band exhibited by a chiral liquid crystal polymer layer.

The marking can be affixed directly on the substrate.

The marking can be at least partially covered by a black layer transparent to the infrared, or a protective layer or a scratch off layer or a chiral liquid crystal polymer coating layer or a birefringent coating layer.

The marking can comprise one or more intermediate layers. The one or more intermediate layers can comprise a resin layer, a gloss modifying layer, a varnish layer, a resin layer which is able to change the position of the selective reflection band exhibited by a chiral liquid crystal polymer layer, or a black layer transparent to infrared.

The one or more intermediate patterned resins can comprise flakes which are the same or different to the flakes of the distribution of flakes at least partially overlapping the mono-dimensional and/or bidimensional code.

The marking can be at least partially embossed.

The mono-dimensional and/or bidimensional code can comprise a material that is readable at wavelengths at which the flakes are invisible. The material can be readable in the IR range, and the flakes can be invisible in the IR range.

The item or good can be the substrate of the marking and the substrate can be selected from a seal, a capsule or a cork, packaging, a cartridge, a container that contains nutraceuticals, pharmaceuticals, foodstuffs or beverages, a banknote, a credit card, a stamp, a tax label, a security document, a passport, an identity card, a driver's license, an access card, a transportation ticket, an event ticket, a voucher, an ink-transfer film, a reflective film, an aluminum foil, a cigarette packaging and a commercial good.

There is also provided a use of the marking disclosed herein for authenticating or identifying or tracking and tracing an item or good.

### BRIEF DESCRIPTION OF THE DRAWINGS

The present invention is further described in the detailed description which follows, in reference to the noted plurality of drawings by way of a non-limiting example of exemplary embodiment of the present invention, in which like reference numerals represent similar parts throughout the several views of the drawings, and wherein:

FIG. 1 to 3 illustrate the main steps of producing a void tamper evidence label according to an embodiment of the invention as exemplified in the Example;

FIG. 4 shows a diagram illustrating the effect of a modifying resin on the selective reflection band (λₘₐₓ) of a salt-containing chiral liquid crystal polymer layer suitable for use in the present invention;

FIG. 5 shows a photograph of a container comprising code printed on the container;

FIG. 6 shows a photograph of a marking comprising a void tamper evidence label as described on FIG. 3, affixed on the code of the container of FIG. 5;

FIG. 7 shows a photograph of the marking of FIG. 6 when viewed through polarized filter so as to facilitate the detection of the distribution of flakes;

FIG. 8 shows an embodiment of the invention wherein a layer including a distribution of flakes is positioned over the indicia on a substrate, and the label can also optionally include a distribution of flakes;

FIG. 9 shows a second embodiment of the invention wherein a self-adhesive label is positioned over the indicia, and a layer including a distribution of flakes is positioned over the self-adhesive label, and the label can also optionally include a distribution of flakes;

FIG. 10 shows a third embodiment of the invention wherein a layer including a distribution of flakes is positioned over the indicia on a substrate, and the label can also optionally include a distribution of flakes, and a distribution of flakes can also be present over the self-adhesive label; and

FIG. 11 shows a fourth embodiment of the invention wherein at least a portion of the marking can be preformed prior to being positioned at least partially over indicia on a substrate.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise. For example, reference to “a magnetic material” would also mean that mixtures of one or more magnetic materials can be present unless specifically excluded.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The various embodiments disclosed herein can be used separately and in various combinations unless specifically stated to the contrary.

In accordance with non-limiting embodiments, there is provided a marking that includes a self-adhesive label associated therewith. The self-adhesive label is associated with the marking so that removal and replacement of the self-adhesive label leads to variation of a detectable pattern. Therefore, tampering with the self-adhesive label, such as removal and replacement of the self-adhesive label, provides a change in the marking so that tampering of the marking can be ascertained.

Thus, the auto-adhesive label is associated with the at least one distribution of flakes layers so that removal and replacement of the auto-adhesive label will be evidence of tampering of the marking. The marking will have detectable characteristics associated with the one or more distribution of flakes layers that will be modified when the auto-adhesive label is tampered. Therefore, even if the auto-adhesive label is replaced after tampering or a new auto-adhesive label is associated with the marking, the detectable characteristics will be modified. For example, manipulation of the auto-adhesive label can change the positioning of flakes within a distribution of flakes in one or more layers, and this change in positioning will be evident upon subjecting the marking to reading.

Prior to general discussion of various layers that can be included in the marking, there is provided below a discussion of different embodiments of the present invention with respect to exemplary embodiments illustrated in the figures of drawings.

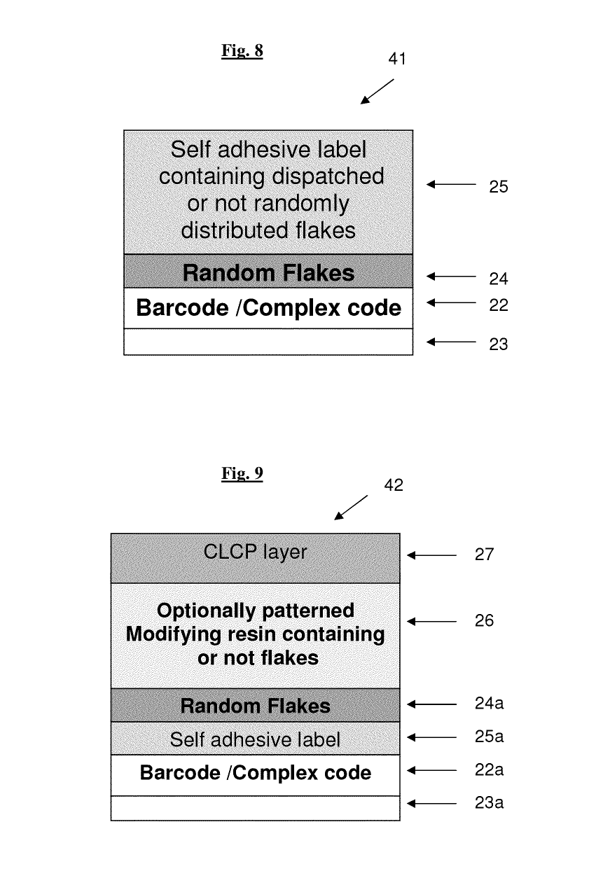

According to one embodiment, as illustrated in FIG. 8, the marking 41 includes indicia 22 on substrate 23 at least partially covered with a layer comprising a distribution of flakes 24, which are preferably randomly distributed. Onto the distribution of flakes layer 24 is placed a self-adhesive label 25. Thus, in this embodiment, removal of the self-adhesive label 25 from the layer comprising a distribution of flakes 24 will effect positioning of detectable elements in the marking, e.g., the positioning of flakes in the distribution of flakes layer 24.

In this embodiment, the self-adhesive label 25 can also contain a distribution of flakes, which are preferably randomly distributed, so that manipulation of the label, should result in changing positioning of flakes in each of the distribution of flakes layer 24 and the self-adhesive layer 25.

According to another embodiment, as illustrated in FIG. 9, the marking 42 including indicia 22a on substrate 23a is at least partially covered with a self-adhesive label 25a. A layer comprising a distribution of flakes 24a, which are preferably randomly distributed, is included above the self-adhesive label 25a. A modifying resin layer 26 is located above the distribution of flakes 24a, which can also include flakes which are preferably randomly distributed. A chiral liquid crystal polymer (CLCP) layer 27 is located above the modifying resin layer 26. The modifying resin layer is able to change the position of the selective reflection band exhibited by the CLCP layer.

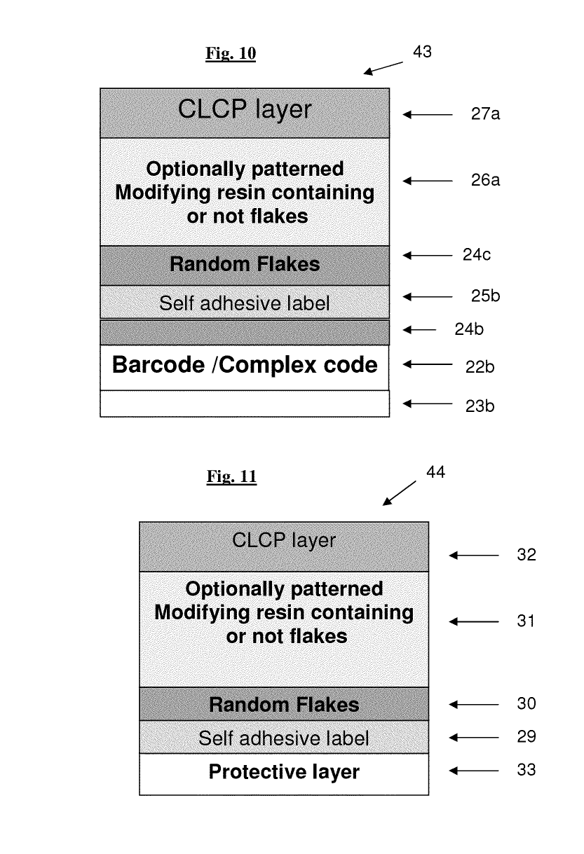

According to another embodiment, as illustrated in FIG. 10, there can be included a marking 43 including a distribution of flakes layers, preferably randomly distributed, in more than one layer, such as a combination of two distribution of flakes layers in the marking. Thus, FIG. 10 shows indicia 22b on substrate 23b wherein the indicia 22b is at least partially covered with a distribution of flakes 24b. Onto the distribution of flakes 24b is placed a self-adhesive label 25b. A second distribution of flakes 24c is included above the self-adhesive label 25b. A modifying resin layer 26a is located above the second distribution of flakes 24c. A chiral liquid crystal polymer (CLCP) layer 27a is located above the modifying resin layer 26a. The modifying resin layer 26a is able to change the position of the selective reflection band exhibited by the CLCP layer 27a. One or both of the self-adhesive label and the modifying resin layer can also contain a distribution of flakes, preferably a random distribution of flakes.

The various layers can be placed in the marking by including layer after layer on the substrate containing the indicia. Thus, one layer can be at least partially positioned over the indicia on the substrate, and thereafter one or more layers can be subsequently placed to at least partially cover the first layer and/or a plurality of layers previously laminated prior to inclusion in the marking can be placed as layers of the marking.

In one preferred embodiment, there is provided an auto-adhesive marking member 44 as illustrated in FIG. 11. This auto-adhesive marking member includes, in the following order and in at least a partially overlapping relationship, a layer comprising a label stock layer or a self-adhesive label 29; a layer including a distribution of flakes 30, the flakes being the same or different, a modifying resin layer 31, and a chiral liquid crystal polymer (CLCP) layer 32, the modifying resin layer being able to change the position of the selective reflection band exhibited by the CLCP layer. In this embodiment, the auto-adhesive layer, after removal of an optionally protective layer 33 from the auto-adhesive layer 29 can be partially positioned over the indicia on a substrate. Other layers, such as a protective layer, or any layer providing desired functions to the marking can be optionally added after application of the auto-adhesive marking member.

As is apparent, the marking can include one or more layers of a distribution of flakes. In such an instance, the marking can include the distribution of flakes in various layers in the marking to provide different combinations of distributions of flakes having the same or different characteristics, such as distribution of flakes in (i) the adhesive layer, such as adhesive label layer 29 in FIG. 11, (2) one or more layers below the adhesive layer, and/or (3) one or more layers above the adhesive layer, including the modify resin layer.

As seen from the above, the marking includes elements associated therewith, including the distribution of flakes, that permits evidence of tampering, tracking and tracing, etc. of a good upon which the marking is included. As another example, it is seen that by even using a plurality of detectable parameters, such as more than two different sizes of the same flakes and/or different flakes and/or multiple different flakes, and/or detectable elements in addition to the flakes, nearly unlimited coding possibilities are readily obtainable with the flakes disclosed herein. In each situation, the code generated can reflect the nature of the overall set of information associated with the nature of the flakes used in the marking. Accordingly, it can be seen that by increasing the number of detectable parameters, the coding possibilities are nearly unlimited. See, for example, U.S. application Ser. No. 13/801,053, filed Mar. 13, 2013, or US 2010/0200649 A1, the disclosures of which are incorporated by reference herein in their entireties.

The substrate for use in the present invention is not particularly limited and can be of various types. The substrate may, for example, consist (essentially) of or comprise one or more of a metal (for example, in the form of a container such as a can, a capsule or a closed cartridge for holding various items such as, e.g., nutraceuticals, pharmaceuticals, beverages or foodstuffs), a fabric, a coating, and equivalents thereof, glass (for example, in the form of a container such as a bottle for holding various items such as, e.g., nutraceuticals, pharmaceuticals, beverages or foodstuffs), cardboard (e.g., in the form of packaging), paper, and a polymeric material such as, e.g., PET or polyethylene (e.g., in the form of a container or as a part of a security document), packaging of cigarette. It is pointed out that these substrate materials are given exclusively for exemplifying purposes, without restricting the scope of the invention.

The substrate may advantageously have indicia thereon, preferably a code, and more preferably a mono-dimensional and/or a bidimensional code. To protect the indicia, preferably a code, and more preferably a mono-dimensional and/or a bidimensional code, or the opening of a container made with this substrate, a void tamper evidence label comprising a distribution of flakes is produced and is applied onto the indicia, which is preferably a code.

The code can be a bar code or complex code. By complex code it is meant that the code is not similar to a Barcode or convention 2D code such as a datamatrix, but a sum of dots or elements different from line or small black cell (such as those present in a datamatrix). The sum of dots or elements are oriented or positioned in a such manner that they could serve as a basis for a binary code, where a specific orientation or position could be interpreted as a 0 and 1 value which constitutes a binary code. Preferably the code is a mono-dimensional code or a bidimensional code.

The mono-dimensional code can be a mono-dimensional barcode or a stacked mono-dimensional barcode (i.e. an mono-dimensional optical machine-readable representation of data). The mono-dimensional code can be chosen from the group of UPC, Codabar, Code 25, Code 39, Code 93, Code 128, Code 128A, Code 128b, Code 128C, Code 11, CPC Binary, Dun14, EAN 2, EAN 5, EAN-8, EAN-13, GS1-128, GS1 Databar, HIBC, ITF-14, Latent image Barcode, Pharmacode, Plessey, PLANET, POSTNET, Intelligent Mail barcode, MSI, PostBar, RM4SCC, JAN, Telepen.

The bidimensional code can be a bidimensional barcode (i.e. an bidimensional optical machine-readable representation of data). The bidimensional code can be chosen from the group of 3-DI, Array Tag, Aztec Code, Small Aztec Code, Codablock, Code 1, Code 16K, Code 49, Color Code, Color Construct Code, Compact Matrix Code, CP Code, CyberCode, d-touch, Data Matrix, Datastrip Code, Dot Code A, EZcode, Grid Matrix Code, High Capacity Color Barcode, HueCode, INTACTA CODE, Intercode, JAGTAG, Maxicode, mcode, MiniCode, MicroPDF417, MMCC, Optar, PaperDisk, PDF417, PDMark, QR Code, QuickMark Code, Secure Seal, SmartCode, ShotCode, SPARQCode, SuperCode, Trillcode, UltraCode, UnisCode, VeriCode, WaterCode.

The code, preferably a mono-dimensional and/or bidimensional code, can comprise a material that is readable at wavelengths at which the flakes are invisible. For example, the material can be readable in the IR range, and the flakes are invisible in the IR range.

The code can further comprise, invisible to the unaided eyes, a layer with secure and/or authentication and/or track and trace properties, glyph, encoded data invisible to the unaided eyes, watermark data, encrypted data with private and/or public key, taggant and/or dyes and/or pigments which have luminescent and/or magnetic properties invisible to the unaided eye.

The distribution of flakes can comprise flat flakes, which, on the one hand, have a significant two-dimensional size (typically 50 micrometers or more), and therefore allow for an easy detection and, at the same time, are not easily lost due to friction, wear or crumpling of the document or item carrying the marking, and which, on the other hand, have a small thickness, which makes them compatible with the common printing processes. The flakes can have a total thickness of from about 5 μm to about 100 μm. See, for example, U.S. application Ser. No. 13/801,053, filed Mar. 13, 2013, or US 2010/0200649 A1, the disclosures of which are incorporated by reference herein in their entireties.

The flakes are applied at low surface density, i.e., so as to result in a moderate number of flakes present over the marking, in order to limit the data set representing the marking to a size which can be easily treated and stored on existing processing equipment and at sufficient speed. The random distribution can be detectable in an area of at least 1 mm², preferably 10 mm², more preferably 100 mm². The flake density is preferably not higher than 1000 flakes/mm², more preferably not higher than 100 flakes/mm², more preferably not higher than 35 flakes/mm², and even more preferably not higher than 7 flakes/mm².

The marking area has a sufficiently large, non-microscopic size, so as to facilitate its localization and scanning on the document or item.

The use of a distribution of flakes as an identifier requires the reading of this distribution, and thus should include the presence of a reference mark to locate this distribution of flakes. An advantage of the present invention is the presence of the mono-dimensional or bidimensional code which serves not only as a part of the identifier but also as a reference mark to locate efficiently and easily said distribution of flakes and creates a corresponding unique code that will be useful for track and trace purpose. Another advantage of the marking according to the present invention is the enhanced security against alteration. If the mono-dimensional code or the bidimensional code is altered and becomes unreadable, it keeps its function of reference mark and the code based on the distribution of flakes will be still obtained.

The flakes can comprise a CLCP layer, and eventually an additional layer, such as an additional layer made with luminescent and/or magnetic material. At least part of the flakes can be chiral liquid crystal polymer (CLCP) flakes having at least one layer of CLCP. Such polymers reflect a circular polarized light component; that means that within a determined wavelength range, light having a determined circular polarization state (left- or right-handed, depending on the polymer) is predominantly reflected. Cholesteric liquid crystal polymers have a molecular order in the form of helically arranged molecular stacks. This order is at the origin of a periodic spatial modulation of the material's refractive index, which in turn results in a selective transmission/reflection of determined wavelengths and polarizations of light. The particular situation of the helical molecular arrangement in CLCPs causes the reflected light to be circular polarized, left-handed or right-handed, depending on the sense of rotation of the molecular helical stack. A marking, comprising a random distribution of CLCP flakes, provides thus the document or item with a unique optical signature, detectable and distinguishable through its specific reflection of circular polarized light. The flakes can appear in random positions and orientations on the printed document or item. The marking, which can be almost transparent, but distinguishable from the background through its polarization effect, can be used in all kind of authentication, identification, tracking and tracing applications, for all kind of documents or goods. The flakes are considered to be the same, as opposed to different if they fulfill at least one of the conditions: (1) they have the same sizes or shapes or the same group of sizes or shapes (by group of sizes or shapes it is meant that the flakes could be classified in a group having an average means of sizes) or (2) the flakes have the same optical properties or (3) the flakes have the same luminescent properties. By optical properties of the flakes is it mainly considered that it is the λmax (maximum of reflection band). This means that the flakes used in two different layers may be the same (as opposed to different) in that they have the same optical properties but may have different sizes or shapes or group of sizes or shapes in each of the layer.

A chiral liquid crystal precursor composition is used for making a CLCP flake. The chiral liquid crystal precursor composition preferably comprises a mixture of (i) one or more nematic (precursor) compounds A and (ii) one or more cholesteric (i.e., chiral dopant) compounds B (including cholesterol) which are capable of giving rise to a cholesteric state of the composition. The pitch of the obtainable cholesteric state depends on the relative ratio of the nematic and the cholesteric compounds. Typically, the (total) concentration of the one or more nematic compounds A in the chiral liquid crystal precursor composition for use in the present invention will be about five to about twenty times the (total) concentration of the one or more cholesteric compounds B. Thus, the chiral liquid crystal polymer layer can formed from a chiral liquid crystal precursor composition comprising (i) one or more (e.g. two, three, four, five or more and in particular, at least two) different nematic compounds A and (ii) one or more (e.g., two, three, four, five or more) different chiral dopant compounds B which are capable of giving rise to a cholesteric state of the chiral liquid crystal precursor composition upon heating. Further, both the one or more nematic compounds A and the one or more chiral dopant compounds B may comprise at least one compound which comprises at least one polymerizable group. For example, all of the one or more nematic compounds A and all of the one or more chiral dopant compounds B may comprise at least one polymerizable group. The at least one polymerizable group may, for example, comprise a group which is able to take part in a free radical polymerization and in particular, a (preferably activated) unsaturated carbon-carbon bond such as, e.g., a group of formula H₂C═CH—C(O)—.

The chiral liquid crystal precursor composition preferably comprises a mixture of (i) one or more nematic (precursor) compounds A and (ii) one or more cholesteric (i.e., chiral dopant) compounds B (including cholesterol) which are capable of giving rise to a cholesteric state of the composition. The pitch of the obtainable cholesteric state depends on the relative ratio of the nematic and the cholesteric compounds. Typically, the (total) concentration of the one or more nematic compounds A in the chiral liquid crystal precursor composition for use in the present invention will be about five to about twenty times the (total) concentration of the one or more cholesteric compounds B.

Nematic (precursor) compounds A which are suitable for use in the chiral liquid crystal precursor composition are known in the art; when used alone (i.e., without cholesteric compounds) they arrange themselves in a state characterized by its birefringence. Non-limiting examples of nematic compounds A which are suitable for use in the present invention are described in, e.g., WO 93/22397, WO 95/22586, EP-B-0 847 432, U.S. Pat. No. 6,589,445, US 2007/0224341 A1. The entire disclosures of these documents are incorporated by reference herein.

A preferred class of nematic compounds for use in the present invention comprises one or more (e.g., 1, 2 or 3) polymerizable groups, the same or different from each other, per molecule. Examples of polymerizable groups include groups which are capable of taking part in a free radical polymerization and in particular, groups comprising a carbon-carbon double or triple bond such as, e.g., an acrylate moiety, a vinyl moiety or an acetylenic moiety. Particularly preferred as polymerizable groups are acrylate moieties.

The nematic compounds for use in the present invention further may comprise one or more (e.g., 1, 2, 3, 4, 5 or 6) optionally substituted aromatic groups, preferably phenyl groups. Examples of the optional substituents of the aromatic groups include those which are set forth herein as examples of substituent groups on the phenyl rings of the chiral dopant compounds of formula (I) such as, e.g., alkyl and alkoxy groups.

Examples of groups which may optionally be present to link the polymerizable groups and the aryl (e.g., phenyl) groups in the nematic compounds A include those which are exemplified herein for the chiral dopant compounds B of formula (I) (including those of formula (IA) and formula (IB) set forth below). For example, the nematic compounds A may comprise one or more groups of formulae (i) to (iii) which are indicated below as meanings for A₁ and A₂ in formula (I) (and formulae (IA) and (IB)), typically bonded to optionally substituted phenyl groups. Specific non-limiting examples of nematic compounds which are suitable for use in the present invention are given below in the Example.

The one or more cholesteric (i.e., chiral dopant) compounds B for use in the present invention preferably comprise at least one polymerizable group.

Suitable examples of the one or more chiral dopant compounds B include those of formula (I):

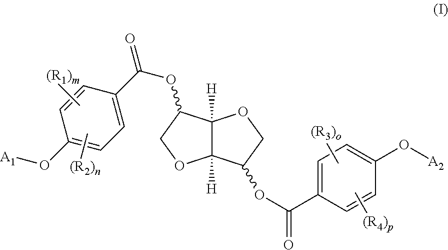

wherein:
R₁, R₂, R₃, R₄, R₅, R₆, R₇ and R₈ each independently denote C₁-C₆ alkyl and C₁-C₆ alkoxy;
A₁ and A₂ each independently denote a group of formula (i) to (iii):

—[(CH₂)y-O]_{z}—C(O)—CH═CH₂ (i);

—C(O)-D₁-O—[(CH₂)_{y}—O]_{z}—C(O)—CH═CH₂ (ii);

—C(O)-D₂-O—[(CH₂)_{y}—O]_{z}—C(O)—CH═CH₂ (iii);

D₁ denotes a group of formula

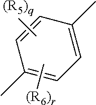

D₂ denotes a group of formula

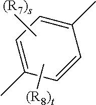

m, n, o, p, q, r, s, and t each independently denote 0, 1, or 2;
y denotes 0, 1, 2, 3, 4, 5, or 6;
z equals 0 if y equals 0 and z equals 1 if y equals 1 to 6.

In one aspect, the one or more chiral dopant compounds B may comprise one or more isomannide derivatives of formula (IA):

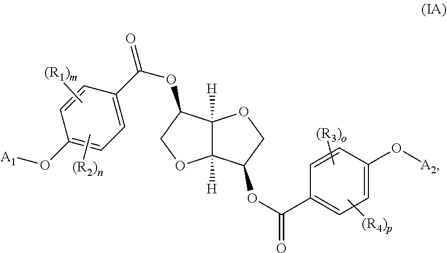

wherein:
R₁, R₂, R₃, R₄, R₅, R₆, R₇ and R₈ each independently denote C₁-C₆ alkyl and C₁-C₆ alkoxy;
A₁ and A₂ each independently denote a group of formula (i) to (iii):

—[(CH₂)y-O]z-C(O)—CH═CH₂ (i);

—C(O)-D₁-O—[(CH₂)y-O]z-C(O)—CH═CH₂ (ii);

—C(O)-D₂-O—[(CH₂)y-O]z-C(O)—CH═CH₂ (iii);

D₁ denotes a group of formula

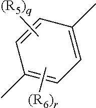

D₂ denotes a group of formula

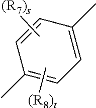

m, n, o, p, q, r, s, and t each independently denote 0, 1, or 2;
y denotes 0, 1, 2, 3, 4, 5, or 6;
z equals 0 if y equals 0 and z equals 1 if y equals 1 to 6.

In one embodiment of the compounds of formula (IA) (and of compounds of formula (I)), R₁, R₂, R₃, R₄, R₅, R₆, R₇ and R₈ each independently denote C₁-C₆ alkyl. In an alternative embodiment, R₁, R₂, R₃, R₄, R₅, R₆, R₇ and R₈ in formula (IA) (and in formula (I)) each independently denote C₁-C₆ alkoxy.

In another embodiment of the compounds of formula (I) and of formula (IA), A₁ and A₂ each independently denote a group of formula —[(CH₂)_{y}—O]_{z}—C(O)—CH═CH₂; R₁, R₂, R₃ and R₄ each independently denote C₁-C₆ alkyl; and m, n, o, and p each independently denote 0, 1, or 2. In yet another embodiment, A₁ and A₂ in formula (I) and formula (IA) each independently denote a group of formula —[(CH₂)_{y}—O]_{z}—C(O)—CH═CH₂; R₁, R₂, R₃ and R₄ each independently denote C₁-C₆ alkoxy; and m, n, o, and p each independently denote 0, 1, or 2.

In another embodiment of the compounds of formula (IA) (and of formula (I)), A₁ and A₂ each independently denote a group of formula —C(O)-D₁-O—[(CH₂)_{y}—O]_{z}—C(O)—CH═CH₂ and/or of formula —C(O)-D₂-O—[(CH₂)_{y}—O]_{z}—C(O)—CH═CH₂; and R₁, R₂, R₃, R₄, R₅, R₆, R₇ and R₈ each independently denote C₁-C₆ alkyl. In an alternative embodiment, A₁ and A₂ in formula (IA) (and in formula (I)) each independently denote a group of formula —C(O)-D₁-O—[(CH₂)_{y}—O]_{z}—C(O)—CH═CH₂ and/or a group of formula —C(O)-D₂-O—[(CH₂)_{y}—O]_{z}—C(O)—CH═CH₂; and R₁, R₂, R₃, R₄, R₅, R₆, R₇ and R₈ each independently denote C₁-C₆ alkoxy.

In another aspect, the one or more chiral dopant compounds B may comprise one or more isosorbide derivatives represented by formula (IB):

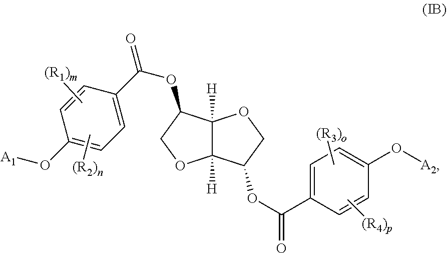

wherein:
R₁, R₂, R₃, R₄, R₅, R₆, R₇ and R₈ each independently denote C₁-C₆ alkyl and C₁-C₆ alkoxy;
A₁ and A₂ each independently denote a group of formula (i) to (iii):

—[(CH₂)y-O]z-C(O)—CH═CH₂ (i);

—C(O)-D₁-O—[(CH₂)y-O]z-C(O)—CH═CH₂ (ii);

—C(O)-D₂-O—[(CH₂)y-O]z-C(O)—CH═CH₂ (iii);

D₁ denotes a group of formula

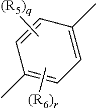

D₂ denotes a group of formula

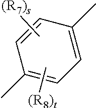

m, n, o, p, q, r, s, and t each independently denote 0, 1, or 2;
y denotes 0, 1, 2, 3, 4, 5, or 6;
z equals 0 if y equals 0 and z equals 1 if y equals 1 to 6.

In one embodiment of the compounds of formula (IB), R₁, R₂, R₃, R₄, R₅, R₆, R₇ and R₈ each independently denote C₁-C₆ alkyl. In an alternative embodiment, R₁, R₂, R₃, R₄, R₅, R₆, R₇ and R₈ in formula (IB) each independently denote C₁-C₆ alkoxy.

In another embodiment of the compounds of formula (IB), A₁ and A₂ each independently denote a group of formula —[(CH₂)_{y}—O]_{z}—C(O)—CH═CH₂; R₁, R₂, R₃ and R₄ each independently denote C₁-C₆ alkyl; and m, n, o, and p each independently denote 0, 1, or 2. In yet another embodiment, A₁ and A₂ in formula (IB) each independently denote a group of formula —[(CH₂)_{y}—O]_{z}—C(O)—CH═CH₂; R₁, R₂, R₃ and R₄ each independently denote C₁-C₆ alkoxy; and m, n, o, and p each independently denote 0, 1, or 2.

In another embodiment of the compounds of formula (IB), A₁ and A₂ each independently denote a group of formula —C(O)-D₁-O—[(CH₂)_{y}—O]_{z}—C(O)—CH═CH₂ and/or of formula —C(O)-D₂-O—[(CH₂)_{y}—O]_{z}—C(O)—CH═CH₂; and R₁, R₂, R₃, R₄, R₅. R₆, R₇ and R₈ each independently denote C₁-C₆ alkyl. In an alternative embodiment, A₁ and A₂ in formula (IB) each independently denote a group of formula —C(O)-D₁-O—[(CH₂)_{y}—O]_{z}—C(O)—CH═CH₂ and/or a group of formula —C(O)-D₂-O—[(CH₂)_{y}—O]_{z}—C(O)—CH═CH₂; and R₁, R₂, R₃, R₄, R₅, R₆, R₇ and R₈ each independently denote C₁-C₆ alkoxy.

In a preferred embodiment, the alkyl and alkoxy groups of R₁, R₂, R₃, R₄, R₅, R₆, R₇ and R₈ in formulae (I), (IA) and (IB) may comprise 3, 4, 6 or 7 carbon atoms and in particular, 4 or 6 carbon atoms.

Examples of alkyl groups comprising 3 or 4 carbon atoms include isopropyl and butyl. Examples of alkyl groups comprising 6 or 7 carbon atoms include hexyl, 2-methylpentyl, 3-methylpentyl, 2,2-dimethylpentyl, and 2,3-dimethylpentyl.

Examples of alkoxy groups comprising 3 or 4 carbon atoms include isopropoxy, but-1-oxy, but-2-oxy, and tert-butoxy. Examples of alkoxy groups comprising 6 or 7 carbon atoms include hex-1-oxy, hex-2-oxy, hex-3-oxy, 2-methylpent-1-oxy, 2-methylpent-2-oxy, 2-methylpent-3-oxy, 2-methylpent-4-oxy, 4-methylpent-1-oxy, 3-methylpent-1-oxy, 3-methylpent-2-oxy, 3-methylpent-3-oxy, 2,2-dimethylpent-1-oxy, 2,2-dimethylpent-3-oxy, 2,2-dimethylpent-4-oxy, 4,4-dimethylpent-1-oxy, 2,3-dimethylpent-1-oxy, 2,3-dimethylpent-2-oxy, 2,3-dimethylpent-3-oxy, 2,3-dimethylpent-4-oxy, and 3,4-dimethylpent-1-oxy.

The one or more chiral dopant compounds B will usually be present in a total concentration of from about 0.1% to about 30% by weight, e.g., from about 0.1% to about 25%, or from about 0.1% to about 20% by weight, based on the total weight of the composition. For example, in the case of inkjet printing the best results will often be obtained with concentrations of from 3% to 10% by weight, e.g., from 5% to 8% by weight, based on the total weight of the polymer composition. The one or more nematic compounds A will often be present in a concentration of from about 30% to about 50% by weight, based on the total weight of the polymer composition.

A chiral liquid crystal precursor composition will usually comprise a solvent to adjust its viscosity to a value which is suitable for the employed application method. Suitable solvents are known to those of skill in the art. Non-limiting examples thereof include low-viscosity, slightly polar and aprotic organic solvents, such as, e.g., methyl ethyl ketone (MEK), acetone, cyclohexanone, ethyl acetate, ethyl 3-ethoxypropionate, toluene, and mixtures of two or more thereof.

If a chiral liquid crystal precursor composition (comprising one more polymerizable monomers) is to be cured/polymerized by UV radiation the composition will also comprise at least one photoinitiator that shows a non-negligible solubility in the composition. Non-limiting examples of the many suitable photoinitiators include α-hydroxyketones such as 1-hydroxy-cyclohexyl-phenyl-ketone and a mixture (e.g., about 1:1) of 1-hydroxy-cyclohexyl-phenyl-ketone and one or more of benzophenone, 2-hydroxy-2-methyl-1-phenyl-1-propanone, and 2-hydroxy-1-[4-(2-hydroxyethoxy)phenyl]-2-methyl-1-propanone; phenylglyoxylates such as methylbenzoylformate and a mixture of oxy-phenyl-acetic acid 2-[2-oxo-2-phenyl-acetoxy-ethoxy]-ethyl ester and oxy-phenyl-acetic 2-[2-hydroxy-ethoxy]-ethyl ester; benzyldimethyl ketals such as alpha, alpha-dimethoxy-alpha-phenylacetophenone; α-aminoketones such as 2-benzyl-2-(dimethylamino)-1-[4-(4-morpholinyl)phenyl]-1-butanone and 2-methyl-1-[4-(methylthio)phenyl]-2-(4-morpholinyl)-1-propanone; phosphine oxide and phosphine oxide derivatives such as diphenyl (2,4,6-trimethylbenzoyl)-phosphine oxide; phenyl bis(2,4,6-trimethylbenzoyl) supplied by Ciba;

and also thioxanthone derivatives such as Speedcure ITX (CAS 142770-42-1), Speedcure DETX (CAS 82799-44-8), Speedcure CPTX (CAS 5495-84-1-2 or CAS 83846-86-0) supplied by Lambson.

If a chiral liquid crystal precursor composition is to be cured by a method which is different from irradiation with UV light such as, e.g., by means of high-energy particles (e.g., electron beams), X-rays, gamma-rays, etc. the use of a photoinitiator can, of course, be dispensed with.

Non-limiting specific examples of chiral dopant compounds B of formula (I) for use in the present invention are provided in the Examples below.

Additionally, the chiral liquid crystal polymer layers can comprise components, such as disclosed in US 2011-0101088 A1 and WO 2010/115879 A2 and its U.S. National Stage application Ser. No. 13/262,348, which are incorporated by reference herein in their entireties. The at least two chiral liquid crystal polymer (CLCP) layers can comprise components A) and B), wherein

A) is 20-99.5 wt % of at least one three-dimensionally crosslinkable compound of the formula (1)

Y¹-A¹-M¹-A²-Y² (1)

wherein

Y¹, Y² are equal or different, and represent polymerizable groups;

A¹, A² are equal or different residues of the general formula CₙH₂ₙ, wherein n is an integer between 0 and 20, and wherein at least one methylene group may be replaced by an oxygen atom;

M¹ has the formula

—R¹—X¹—R²—X²—R³—X³—R⁴—;

wherein

R¹ to R⁴ are equal or different bivalent residues chosen from the group consisting of —O—, —COO—, —COHN—, —CO—, —S—, —C═C—, CH—CH—, —N≡N—, —N═N(O)—, and a C—C bond; and wherein R²—X²—R³ or R²—X² or R²—X²—R³—X³ may as well be a C—C bond;

X¹ to X³ are equal or different residues chosen from the group consisting of 1,4-phenylene; 1,4-cyclohexylene; heteroarylenes having 6 to 10 atoms in the aryl core and 1 to 3 heteroatoms from the group consisting of O, N and S, and carrying substituents B¹, B² and/or B³; cycloalkylenes having 3 to 10 carbon atoms and carrying substituents B¹, B² and/or B₃;

wherein

B¹ to B³ are equal or different substituents chosen from the group consisting of hydrogen, C₁-C₂₀-alkoxy, C₁-C₂₀-alkylthio, C₁-C₂₀-alkylcarbonyl, alkoxycarbonyl, C₁-C₂₀-alkylthiocarbonyl, —OH, —F, —Cl, —Br, —I, —CN, —NO₂, Formyl, Acetyl, and alkyl-, alkoxy-, or alkylthio-residues with 1 to 20 carbon atoms having a chain interrupted by ether oxygen, thioether, sulfur or ester groups; and

B) is 0.5 to 80 wt % of at least one chiral compound of the formula (2)

V¹-A¹-W¹—Z—W²-A²-V² (2)

wherein

V¹, V² are equal or different and represent a residue of the following: acrylate, methacrylate, epoxy, vinyl ether, vinyl, isocyanate, C₁-C₂₀-alkyl, C₁-C₂₀-alkoxy, alkylthio, C₁-C₂₀-alkylcarbonyl, C₁-C₂₀-alkoxycarbonyl, C₁-C₂₀-alkylthiocarbonyl, —OH, —F, —Cl, —Br, —I, —CN, —NO₂, Formyl, Acetyl, as well as alkyl-, alkoxy-, or alkylthio-residues with 1 to 20 carbon atoms having a chain interrupted by ether oxygen, thioether sulfur or ester groups, or a cholesterol residue;

A¹, A² are as indicated above;

W¹, W² have the general formula

—R¹—X¹—R²—X²—R³—,

wherein

R¹ to R³ are as indicated above, and wherein R² or R²—X² or X¹—R²—X²—R³ may also be a C—C bond;

X¹, X² are as indicated above;

Z is a divalent chiral residue chosen from the group consisting of dianhydrohexites, hexoses, pentoses, binaphthyl derivatives, biphenyl derivatives, derivatives of tartaric acid, and optically active glycols, and a C—C bond in the case where V¹ or V² is a cholesterol residue.

The component B) can be selected from at least one of AnABIs-(2-[4-(acryloyloxy)-benzoyl]-5-(4-methoxybenzoyl)-isosorbid), DiABIs (di-2,5-[4-(acryloloxy)-benzoyl]-isosorbid), and DiABIm (di-2,5[(4′-acryloyloxy)-benzoyl]-isomannid).

The CLCP flakes can further comprise an additional layer made with luminescent and/or magnetic material.

The additional layer made with luminescent and/or magnetic material can comprise a magnetic material, and the magnetic material can comprise at least one material selected from ferromagnetic materials, ferrimagnetic materials, paramagnetic materials, and diamagnetic materials. For example, the magnetic material can comprise at least one material selected from metals and metal alloys comprising at least one of iron, cobalt, nickel, and gadolinium. For example, the magnetic material can comprise, without limitation, an alloy of iron, cobalt, aluminum, and nickel (with or without copper, niobium, and/or tantalum), such as Alnico, or an alloy of titanium, nickel, cobalt, aluminum, and iron, such as Ticonal; ceramics; and ferrites. The magnetic material can also comprise at least one material selected from inorganic oxide compounds, ferrites of formula MFe204 wherein M represents Mg, Mn, Co, Fe, Ni, Cu or Zn, and garnets of formula A3B5O12 wherein A represents La, Ce, Pr, Nd, Sm, Eu, Gd, Tb, Dy, Ho, Er, Tm, Yb, Lu or Bi and B represents Fe, Al, Ga, Ti, V, Cr, Mn or Co. The magnetic material comprises at least one of a soft magnetic material and a hard magnetic material.

The additional layer made with luminescent and/or magnetic material can comprise a luminescent material comprising one or more lanthanide compounds. The luminescent material can comprise at least one complex of a lanthanide and a β-diketo compound.

The additional layer made with luminescent and/or magnetic material can comprise at least one magnetic material and at least one lanthanide compound. The additional layer made with luminescent and/or magnetic material can comprise at least one magnetic material and at least one complex of a lanthanide and a β-diketo compound.

The CLCP flakes can be visible and/or invisible to the unaided eyes.

The distribution of flakes can comprise different types of flakes. The distribution of flakes can comprise at least two different sizes of flakes and/or two different aspect ratios of flakes. The different types of flakes can include flakes having the same color-shift properties, or flakes having different color-shift properties. For example, the different types of flakes can have the same color shift properties and different polarization properties. The different types of flakes can be in the visible range of the electromagnetic spectrum, or in the invisible range of the electromagnetic spectrum.

The position of a selective reflection band exhibited by the flakes can be the same or different. The difference between the position of a selective reflection band can be of at least 10 nm, or at least 20 nm, or at least 30 nm, or in a range of 20 nm to 100 nm.

The position of a selective reflection band exhibited by said flakes can be comprised between 400 to 1200 nm.

The flakes can be distributed randomly.

The flakes can have the same or different circular polarization properties.

The flakes, such as the flakes at least partially overlapping the code, preferably the mono-dimensional and/or bidimensional code, can be dispersed in a binder. The binder can be the same as the modifying resin used in the modifying resin layer, which will be described below. Thus, the binder can be a resin (also called modifying resin) which is able to change the position of the selective reflection band exhibited by a chiral liquid crystal polymer layer in contact with said resin, the chiral liquid crystal polymer layer (called salt-containing chiral liquid crystal polymer layer) being made from a chiral liquid crystal precursor composition comprising at least one salt that changes (usually in a concentration-dependent manner) the position of a selective reflection band (λmax) exhibited by the chiral liquid crystal polymer layer, compared to the position of the selective reflection band exhibited by a chiral liquid crystal polymer layer that does not contain the at least one salt. Thus, the resin (also called modifying resin) changes the position of the selective reflection band exhibited by the salt-containing chiral liquid crystal polymer layer. It is thus possible to get a salt-containing chiral liquid crystal layer that is locally modified by a modifying resin.

The modifying resin may shift the position of the selective reflection band exhibited by the salt-containing chiral liquid crystal polymer layer by at least about 5 nm, preferably 10 nm, more preferably 20 nm, and/or may shift the position to shorter wavelengths and/or the shifted position of the selective reflection band may be in the visible range. In this regard, it is noted that “shifting the position of the selective reflection band” means shifting λₘₐₓ as measured using an analytical spectral device that measures the reflectance of a sample in the infrared-near-infrared-visible-UV range of the spectrum, such as the LabSpec Pro device made by Analytical Spectral Devices Inc. of Boulder, Colo.

The modifying resin may have been provided by at least one of continuous ink-jet printing, drop-on-demand ink-jet printing, valve-jet printing, spray coating, flexography, gravure printing, offset, dry offset printing, letterpress printing, pad printing and screen printing.

At least one or more polymerizable monomers can be used to provide the modifying resin for changing the position of the selective reflection band exhibited by the cured chiral liquid crystal precursor composition. The at least one or more polymerizable monomers may comprise at least two unsaturated carbon-carbon bonds and/or at least one of the one or more polymerizable monomers may comprise at least one heteroatom, preferably selected from O, N and S and in particular, O and/or N. For example, at least one of the one or more polymerizable monomers for providing the modifying resin may comprise one or more groups (e.g., one, two, three, four, five, six, or more groups) of formula H₂C═CH—C(O)— or H₂C═C(CH₃)—C(O)—. Non-limiting examples of corresponding monomers include polyether acrylates, modified polyether acrylates (such as, e.g., amine-modified polyether acrylates), polyester acrylates, modified polyester acrylates (such as, e.g., amine-modified polyester acrylates), hexafunctional polyester acrylates, tetrafunctional polyester acrylates, aromatic difunctional urethane acrylates, aliphatic difunctional urethane acrylates, aliphatic trifunctional urethane acrylates, aliphatic hexafunctional urethane acrylates, urethane monoacrylates, aliphatic diacrylates, bisphenol A epoxy acrylates, modified bisphenol A epoxy acrylates, epoxy acrylates, modified epoxy acrylates (such as, e.g., fatty acid modified epoxy acrylates), acrylic oligomers, hydrocarbon acrylate oligomers, ethoxylated phenol acrylates, polyethylene glycol diacrylates, propoxylated neopentyl glycol diacrylates, diacrylated bisphenol A derivatives, dipropylene glycol diacrylates, hexanediol diacrylates, tripropylene glycol diacrylates, polyether tetraacrylates, ditrimethylol propane tetraacrylates, dipentaerythritol hexaacrylates, mixtures of pentaerythritol tri- and tetraacrylates, dipropylene glycol diacrylates, hexanediol diacrylates, ethoxylated trimethylol propane triacrylates, and tripropylene glycol diacrylates. Another type of resin that can be used are aqueous resins such as polyamide resins, for example CAS No 175893-71-7, CAS No 303013-12-9, CAS No 393802-62-5, CAS No 122380-38-5, CAS No 9003-39-8.

The modifying resin may comprise a radiation-cured resin, for example, a UV-cured resin. Alternatively, the modifying resin may comprise an aqueous resin which may be dried, such as by conventional means such as heat.

The one or more salts of the chiral liquid crystal layer may comprise a metal such as, e.g., an alkali metal and/or an alkaline earth metal. For example, the metal may be selected from one or more of Li, Na.

The modifying resin layer can contain the modifying resin as discussed above. The modifying resin for changing the position of the selective reflection band exhibited by the salt-containing chiral liquid crystal layer may comprise a radiation-cured resin, for example, a UV-cured resin. Another type of resin that can be used in the present invention are aqueous resins, such as polyamide resins, for example CAS No 175893-71-7, CAS No 303013-12-9, CAS No 393802-62-5, CAS No 122380-38-5, CAS No 9003-39-8.

The salt that changes the position of the selective reflection band exhibited by the salt-containing chiral liquid crystal layer may be selected from metal salts and (preferably quaternary) ammonium salts. For example, the at least one salt may comprise at least one salt of a metal such an alkali or alkaline earth metal (e.g., Li, Na), for example, one or more of lithium perchlorate, lithium nitrate, lithium tetrafluoroborate, lithium bromide, lithium chloride, sodium carbonate, sodium chloride, sodium nitrate, and/or one or more (organically substituted) ammonium salts such as tetraalkylammonium salts, for example, one or more of tetrabutylammonium perchlorate, tetrabutylammonium chloride, tetrabutylammonium tetrafluoroborate, and tetrabutylammonium bromide.

Reference is also made herein to U.S. Pat. Nos. 8,426,014, 8,426,011, 8,426,012, 8,426,013 and 8,426,014 for various materials that can be used in the present marking, including modifying resins, modifying agents, chiral liquid crystal compounds, etc., the disclosures of which are incorporated by reference herein in their entireties.

Moreover, as noted above, the marking can be formed directly on the item or good upon which the indicia, preferably code, is contained. Moreover, the marking can also be formed by providing the label member that can be affixed on the item or good at least partially over the indicia, preferably code.

It is well known that an adhesive film can comprise two layers of materials. The first layer is commonly called the carrier material or facestock. It is usually made of paper, polyethylene (PE), polypropylene (PP), Acetate, polyvinylchloride (PVC) or polyethyleneeterephthalate (PET). One side of the carrier material is coated with an adhesive which constitutes the second layer of an auto-adhesive film. This adhesive film can also be called pressure sensitive adhesive. The other side of the carrier material is sometimes but not always treated to increase its printability.

The auto-adhesive label can also contain one or more additional layers. For example, the adhesive film can include one or more layers of a distribution of flakes and/or can contain a distribution of flakes directly in a layer having an adhesive surface.

In such an instance, the distribution of flakes can be included in the adhesive film as compared to above and/or below the adhesive film. Thus, the auto-adhesive label can contain a layer containing a distribution of flakes, and such adhesive label can be used with various combinations of markings to have distribution of flakes layers in (i) the adhesive film, (2) below the adhesive film, and/or above the adhesive film.

The adhesive layer can be transparent.

The marking can be at least partially covered by a black layer transparent to the infrared, or a protective layer or a scratch off layer or a birefringent coating layer.

The black layer transparent to the infrared can be formed with an aqueous ink comprising, for instance, diethylene glycol, methyl propanediol, BS (Bayscript Black BS liquid (30% diazo in an aqueous solvent)) and water.

The black layer transparent to the infrared can also be formed with an organic ink comprising, for instance, polyvinyl butyral, LiClO₄, Diazo-Cr, ethyl etoxy propionate and MEK.

The marking can comprise one or more intermediate layers between any of the layers, such as one or more intermediate layers between the indicia, preferably mono-dimensional and/or bidimensional code and the distribution of flakes or the auto-adhesive label and/or one or more intermediate layers between the distribution of flakes and the auto-adhesive layer or the modifying resin layer.

The one or more intermediate layers can comprise a resin layer, a gloss modifying layer, a varnish layer, a resin layer which is able to change the position of the selective reflection band exhibited by a chiral liquid crystal polymer layer, or a black layer transparent to infrared or a void tamper evidence label or a label stock layer.

As noted above, the black layer transparent to the infrared can be formed with an aqueous ink comprising, for instance, diethylene glycol, methyl propanediol, Bayscript Black BS liquid and water. Moreover, the black layer transparent to the infrared can also be formed with an organic ink comprising, for instance, polyvinyl butyral, LiClO₄, Diazo-Cr, ethyl etoxy propionate and MEK.

The one or more intermediate patterned resins can comprise flakes which are the same or different to the flakes of the distribution of flakes at least partially overlapping the indicia, such as the mono-dimensional and/or bidimensional code.

The marking can be embossed or at least part of the marking can be embossed, for instance the one or more intermediate layers with the distribution of flakes can be embossed.

The distribution of flakes can be provided by at least one of printing, coating or bronzing with a liquid, semi-solid or solid composition that comprises the flakes.

The chiral liquid crystal polymer (CLCP) layer can be in the visible range of the electromagnetic spectrum, or in the invisible range of the electromagnetic spectrum.

A chiral liquid crystal precursor composition may also comprise a variety of other optional components which are suitable and/or desirable for achieving a particular desired property of the composition and in general, may comprise any components/substances which do not adversely affect a required property of the composition to any significant extent. Non-limiting examples of such optional components are resins, silane compounds, sensitizers for the photoinitiators (if present), etc. For example, especially a chiral liquid crystal precursor composition for use in the present invention may comprise one or more silane compounds which show a non-negligible solubility in the composition. Non-limiting examples of suitable silane compounds include optionally polymerizable silanes such as those of formula R₁R₂R₃—Si—R₄ wherein R₁, R₂, and R₃ independently represent alkoxy and alkoxyalkoxy having a total of from 1 to about 6 carbon atoms and R₄ represents vinyl, allyl, (C₁₋₁₀)alkyl, (meth)acryloxy(C₁₋₆)alkyl, and glycidyloxy(C₁₋₆)alkyl such as, e.g., vinyltriethoxysilane, vinyltrimethoxysilane, vinyltris(2-methoxyethoxy)silane, 3-methacryloxypropyl-trimethoxysilane, octyltriethoxysilane, and 3-glycidyloxypropyl triethoxysilane from the Dynasylan® family supplied by Evonik.

The concentration of the one or more silane compounds, if present, in the liquid crystal precursor composition will usually be from about 0.5% to about 5% by weight, based on the total weight of the composition.

The additional layer can comprise without limitation, magnetic particles which can be chosen from various magnetic materials, such as without limitation, maghemite and/or hematite, compounds which can fluoresce, such as without limitation, VAT dye, Perylene, Quaterrylene, Terrylene derivatives, such as disclosed in US 2011-0293899 A1, or specific designed fluorescent compounds with specific wavelength of excitation or absorption, lanthanides derivatives having luminescent properties and also specific decay time properties, and/or a colored material, such as riboflavine or flavoinoids which have also the advantages to be edible or less toxic. The additional layer can be transparent, semitransparent or opaque.

The additional layer can be formed from various compositions. For example, the additional layer can be formed form curable binder compositions, such as disclosed in US 2009/0230670 A1, WO 2010/138048 A1, U.S. Pat. No. 4,434,010, U.S. Pat. No. 5,084,351, U.S. Pat. No. 5,171,363, or EP-A-0 227 423, which are incorporated by reference herein in their entireties. Moreover, when magnetic flakes are orientated in the compositions, the orientation can be achieved in the manner disclosed in US 2009/0230670 A1. Suitable binder chemistries can be chosen e.g., from the group of vinylic resins, acrylic resins, such as styrene acrylic copolymer, acrylate resins, urethan-alkyde resins, nitrocelluloses, polyamides, latex, etc., and from mixtures thereof and with other polymers, and the composition can furthermore be either solvent-based or water-based. Additives, such as waxes and/or antifoaming agent can also be included. The waxes may comprise any of a group comprising carnauba, parafin, polyethylene, polypropylene, silicone, polyamide, ethylene vinyl acetate, ethylene butyl acetate, ethylene acrylic acid and polytetrafluoro ethylene. The antifoaming agent may comprise polyglycol, mineral oil, polysiloxanes, hydrophobic silica, silicone or mineral oil. The solvent may comprise, for example, any of ethoxy propanol, n-propanol, ethanol, ethylic acetate, water, iso-propanol, glycol, or a retarder solvent.

The luminescent or lanthanides derivatives above described can be present in the additional layer between 1 to 15%, preferably between 1 to 10%, more preferably between 1 to 5% based on the total weight of the composition. According to the present invention, the magnetic material will be present between 15 to 40%, preferably 30 to 35% based on the total weight of the composition. The size of the magnetic material may be between 0.1 to 2.5 μm, preferably between 0.1 to 0.8 μm, more preferably between 0.3 to 1 μm. One having ordinary skill in the art following the present disclosure can adapt the composition and the contents of luminescent or magnetic material according to the others layers for the films and flakes.

The flakes can include an additional layer comprising a material selected from at least one of magnetic material and luminescent material. The additional layer can include magnetic particles which can be chosen from various magnetic materials, such as without limitation, maghemite and/or hematite, compounds which can fluoresce, such as without limitation, VAT dyes, Perylene, Quaterrylene, Terrylene derivatives, such as disclosed in US 2011-0293899 A1, which is incorporated by reference herein in its entirety, or fluorescent compounds with specific wavelength of excitation or absorption, or lanthanides derivatives having luminescent properties and also specific decay time properties.

Thus, for example, the additional layer can include one or more fluorescent or phosphorescent materials having specific wavelength of excitation or absorption linked to the value of the CLCP layers, which enhances the difficulty to forge or replicate the flakes. Also, the additional layer can be made with different soft magnetic material and/or hard magnetic compounds.

For example, the additional layer includes a mixture of lanthanides and/or luminescent compounds in addition with one or more magnetic materials, such as one or more soft magnetic compounds and/or one or more hard magnetic compounds.

The magnetic material can comprise at least one material selected from ferromagnetic materials, ferrimagnetic materials, paramagnetic materials, and diamagnetic materials. The magnetic material can comprise at least one material selected from metals and metal alloys comprising at least one of iron, cobalt, nickel, and gadolinium. For example, the magnetic material can comprise, without limitation, an alloy of iron, cobalt, aluminum, and nickel (with or without copper, niobium, and/or tantalum), such as Alnico, or an alloy of titanium, nickel, cobalt, aluminum, and iron, such as Ticonal; ceramics; and ferrites. The magnetic material can also comprise at least one material selected from inorganic oxide compounds, ferrites of formula MFe₂O₄ wherein M represents Mg, Mn, Co, Fe, Ni, Cu or Zn, and garnets of formula A₃B5O₁₂ wherein A represents La, Ce, Pr, Nd, Sm, Eu, Gd, Tb, Dy, Ho, Er, Tm, Yb, Lu or Bi and B represents Fe, Al, Ga, Ti, V, Cr, Mn or Co. The magnetic material comprises at least one of a soft magnetic material and a hard magnetic material.

The additional layer can comprise a magnetic layer, such as a metal layer or a magnetic ink layer. The metal layer can be deposited in various manners, such as chemical vapor deposition or physical vapour deposition. One or more protective layers may be useful between the additional layer and the CLCP layers in such an instance. For example, as magnetic material used in a magnetic ink, there can be provided maghemite and/or hematite.

The additional layer when made with magnetic material or even when its present with other compounds (such as luminescent compounds) permits an easy alignment of the flakes when dispersed in a random manner inside a medium which support the flakes when printed in the form of a coding element, such as a marking. The flakes can then achieve a maximum capability for reflectance and detection, and thereby enhance reliability of the generated code for inclusion in a database and reading of the marking.

The luminescent material can comprise one or more lanthanide compounds (having or not specific decay-time properties). The luminescent material can also comprise at least one complex of a lanthanide and a β-diketo compound.

The luminescent material can be a fluorescent or phosphorescent material which reflects the light is a certain range of wavelength. This has a double advantage as the fluorescent or phosphorescent material can be part of the coding, but also the emitted light can back light the detectable materials disposed in the layer above and will render the detectable materials easier to be observed.

Pigments can be those as disclosed in US 2010/0307376 A1, which is incorporated by reference herein in its entirety, such as, without limitation, at least one luminescent lanthanide complex of the formula:

M₃[Ln(A)₃]

wherein M is chosen from the alkali cations Li⁺, Na⁺, K⁺, Rb⁺ and Cs⁺ and mixtures thereof;

wherein Ln is chosen from the trivalent rare-earth cations of Ce, Pr, Nd, Sm, Eu, Gd, Tb, Dy, Ho, Er, Tm, and Yb and mixtures thereof;

and wherein A is a dinegatively charged, tridentate 5- or 6-membered heteroaryl ligand, such as, wherein the dinegatively charged, tridentate 5- or 6-membered heteroaryl ligand A is selected form pyridine, imidazole, triazole, pyrazole, pyrazine, bearing at least one carboxylic group, and preferably ligand A is dipicolinic acid, 4-hydroxypyridine-2,6-dicarboxylic acid, 4-amino-2,6-pyridinecarboxylic acid, 4-ethoxypyr.idine-2,6-dicarboxylic acid, 4-isopropoxypyridine-2,6-dicarboxylic acid and/or 4-methoxypyridine-2,6-dicarboxylic acid and/or Ln is chosen from the trivalent ions of Europium (Eu3+) and/or Terbium (Tb3+). Moreover, the 5 to 6 membered heteroaryl bearing at least one carboxylic group can be further substituted by a group hydroxyl, amino, a C₁-C₆-alkoxy, such as a methoxy, ethoxy, isopropoxy, etc. group or a C₁-C₆-alkyl, such as a methyl, ethyl, isopropyl, etc. group.

Preferably, the distribution of flakes is included into a binder, and the binder can preferably be a modifying resin.

The modifying resin for use in the present invention is not particularly limited as long as it is capable of changing the position of the selective reflection band exhibited by a salt-containing chiral liquid crystal layer. In this regard, it is preferred for the resin to be capable of shifting the position of the selective reflection band by at least about 5 nm, e.g., by at least about 10 nm, by at least about 20 nm, by at least about 30 nm, by at least about 40 nm, or by at least about 50 nm. This capability depends on various factors such as, inter alia, the components of the salt-containing chiral liquid crystal precursor composition, for example, the salt(s) and the chiral dopant(s) comprised therein, and the presence or absence of functional groups in the modifying resin (and thus on the surface thereof).

Examples of modifying resins which are suitable include those made from (one, two, three, four or more) polymerizable monomers which include one or more (e.g., two or three) heteroatoms selected from, e.g., O, N, or S. In this regard, it is to be appreciated that the polymerizable monomers are not limited to those which are polymerizable by free radical polymerization. Rather, these monomers also include, for example, monomers which are polymerizable by cationic and/or anionic polymerization and/or by polycondensation. Accordingly, non-limiting examples of resins which are suitable for the purposes of the present invention include organic resins such as polyacrylates, polymethacrylates, polyvinylethers, polyvinylesters, polyesters, polyethers, polyamides, polyurethanes, polycarbonates, polysulfones, phenolic resins, epoxy resins, and mixed forms of these resins. Mixed inorganic/organic resins such as silicones (e.g., polyorganosiloxanes) are suitable as well. One particular type of resin that can be used in the present invention are aqueous resins such as, e.g., polyamide resins (for example CAS No 175893-71-7, CAS No 303013-12-9, CAS No 393802-62-5, CAS No 122380-38-5, CAS No 9003-39-8).

Non-limiting examples of modifying resins further include those which are made from one or more monomers selected from polyether acrylates, modified polyether acrylates (such as, e.g., amine-modified polyether acrylates), polyester acrylates, modified polyester acrylates (such as, e.g., amine-modified polyester acrylates), hexafunctional polyester acrylates, tetrafunctional polyester acrylates, aromatic difunctional urethane acrylates, aliphatic difunctional urethane acrylates, aliphatic trifunctional urethane acrylates, aliphatic hexafunctional urethane acrylates, urethane monoacrylates, aliphatic diacrylates, bisphenol A epoxy acrylates, modified bisphenol A epoxy acrylates, epoxy acrylates, modified epoxy acrylates (such as, e.g., fatty acid modified epoxy acrylates), acrylic oligomers, hydrocarbon acrylate oligomers, ethoxylated phenol acrylates, polyethylene glycol diacrylates, propoxylated neopentyl glycol diacrylates, diacrylated bisphenol A derivatives, dipropylene glycol diacrylates, hexanediol diacrylates, tripropylene glycol diacrylates, polyether tetraacrylates, ditrimethylol propane tetraacrylates, dipentaerythritol hexaacrylates, mixtures of pentaerythritol tri- and tetraacrylates, dipropylene glycol diacrylates, hexanediol diacrylates, ethoxylated trimethylol propane triacrylates, and tripropylene glycol diacrylates (optionally in combination with one or more monomers which are different from the above monomers).

It is to be appreciated that a modifying resin does not have to be completely cured (polymerized) or dry before it is contacted with a salt-containing chiral liquid crystal precursor composition as long as it is able to withstand the components and in particular, the solvent that may be (and usually will be) present in the (uncured) salt-containing chiral liquid crystal precursor composition (e.g., that the modifying resin does not get dissolved thereby to any significant extent). The curing of an only partially cured modifying resin may be completed, for example, together with the curing of the salt-containing chiral liquid crystal precursor (e.g., by UV-radiation).

Another great advantage over the existing prior art (as illustrated in, e.g., WO 2001/024106, WO 2008/127950, the entire disclosures of which are incorporated by reference herein) is the possibility to create perfect register without using mask techniques. By perfect register it is meant the possibility to have in very few steps and/or process(es) steps a single layer of liquid crystal polymer wherein two or more zones with simultaneously different color shifting properties and/or different positions of the selective reflection band are present, and these zones can be perfectly adjacent without either a gap or an overlap between them. This advantage stems from the fact that the liquid crystal precursor composition is applied in one step, and its properties are locally modified by the modifying resin. To obtain a similar result without the instant method, one would have to apply and cure two or more liquid crystal precursor compositions in successive steps with excessively high precision in order for them to cover adjacent regions without gaps or overlaps. The instant method allows straightforward creation of logo, marking, coding, barcode, pattern, data matrix which contains different information and/or color at the same time. The possibilities afforded by the instant method include using mixtures of modifying resins (e.g., mixtures of two, three, four or more modifying resins), both in the form of cured physical mixtures of two or more modifying resins and in the form of two or more different modifying resins which are (separately) present on different locations of the surface of the substrate. Alternatively or additionally, two or more different chiral liquid crystal precursor compositions which differ, for example, in the concentration of salt(s) contained therein and/or differ by containing different salts therein may also be used. This gives rise to a large number of possible combinations of chiral liquid crystal precursor compositions and modifying resins which may be present on the surface of a single substrate. This large number of possible combinations allows, among others, the possibility of creating a specific code and/or marking which is difficult to counterfeit because anyone who wants to reproduce it would have to know the exact composition of the chiral liquid crystal precursor composition, the type, amount, and concentration of salt(s) contained therein and the nature of the modifying resin(s). The incorporation of additional specific security elements such as, e.g., near-infrared, infrared and/or UV security elements (known exclusively to the producer of the marking) into the liquid crystal precursor composition and/or into the modifying resin, makes counterfeiting even more difficult. Accordingly, the present invention also contemplates and encompasses the use of chiral liquid crystal precursor compositions and modifying resins which comprise such additional specific security elements.

Further, in some cases it may be desirable to coat a part of the surface of the auto-adhesive layer/film with a first (modifying) resin material (comprising the flakes) with modifying properties and to then to apply in one or more other areas of the surface of the auto-adhesive layer/film, a second modifying resin (or even two or more different modifying resins in different areas), where the first and second (and third, etc.) resins differ in their ability to shift the position of the selective reflection band exhibited by the cured salt-containing chiral liquid crystal precursor composition (or of two or more different cured chiral liquid crystal precursor compositions). The second (or third . . . ) modifying resin may also comprise flakes.

It also is to be appreciated that the present invention is not limited to the visible range of the electromagnetic spectrum. For example, a modifying resin may shift all or a part of the selective reflection band exhibited by a cured chiral liquid crystal precursor composition from the IR range to the visible range, or from the visible range to the UV range, or from the IR range to the UV range.

A salt-containing chiral liquid crystal polymer coating layer is then deposited on the auto-adhesive layer/film coated with the resin comprising the flakes.

The salt-containing chiral liquid crystal precursor composition preferably comprises a mixture of (i) one or more nematic compounds A and (ii) one or more cholesteric (i.e., chiral dopant) compounds B (including cholesterol) which are capable of giving rise to a cholesteric state of the composition. The pitch of the obtainable cholesteric state depends on the relative ratio of the nematic and the cholesteric compounds. Typically, the (total) concentration of the one or more nematic compounds A in the chiral liquid crystal precursor composition for use in the present invention will be about four to about fifty times the (total) concentration of the one or more cholesteric compounds B. Often, a chiral liquid crystal precursor composition with a high concentration of cholesteric compounds is not desirable (although possible in many cases) because the one or more cholesteric compounds tend to crystallize, thereby making it impossible to obtain the desired liquid crystal state having specific optical properties.

Nematic compounds A which are suitable for use in the chiral liquid crystal precursor composition are known in the art; when used alone (i.e., without cholesteric compounds) they arrange themselves in a state characterized by its birefringence. Non-limiting examples of nematic compounds A which are suitable for use in the present invention are described in, e.g., WO 93/22397, WO 95/22586, EP-B-0 847 432, U.S. Pat. No. 6,589,445, US 2007/0224341 A1 and JP 2009-300662 A. The entire disclosures of these documents are incorporated by reference herein.

A preferred class of nematic compounds for use in the present invention comprises one or more (e.g., 1, 2 or 3) polymerizable groups, the same or different from each other, per molecule. Examples of polymerizable groups include groups which are capable of taking part in a free radical polymerization and in particular, groups comprising a carbon-carbon double or triple bond such as, e.g., an acrylate moiety, a vinyl moiety or an acetylenic moiety. Particularly preferred as polymerizable groups are acrylate moieties.

The nematic compounds for use in the present invention further may comprise one or more (e.g., 1, 2, 3, 4, 5 or 6) optionally substituted aromatic groups, preferably phenyl groups. Examples of the optional substituents of the aromatic groups include those which are set forth herein as examples of substituent groups on the phenyl rings of the chiral dopant compounds of formula (I) such as, e.g., alkyl and alkoxy groups.

Examples of groups which may optionally be present to link the polymerizable groups and the aryl (e.g., phenyl) groups in the nematic compounds A include those which are exemplified herein for the chiral dopant compounds B of formula (I) (including those of formula (IA) and formula (IB) set forth below). For example, the nematic compounds A may comprise one or more groups of formulae (i) to (iii) which are indicated below as meanings for A₁ and A₂ in formula (I) (and formulae (IA) and (IB)), typically bonded to optionally substituted phenyl groups. Specific non-limiting examples of nematic compounds which are suitable for use in the present invention are given below in the Example.

The one or more cholesteric (i.e., chiral dopant) compounds B for use in the present invention preferably comprise at least one polymerizable group.

As set forth above, suitable examples of the one or more chiral dopant compounds B include those of formula (I):

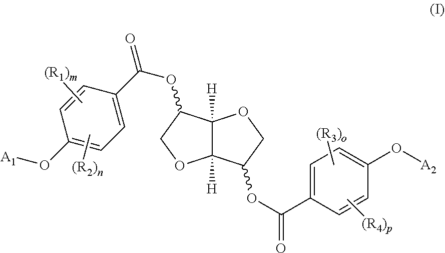

wherein:
R₁, R₂, R₃, R₄, R₅, R₆, R₇ and R₈ each independently denote C₁-C₆ alkyl and C₁-C₆ alkoxy;
A₁ and A₂ each independently denote a group of formula (i) to (iii):

—[(CH₂)y-O]_{z}—C(O)—CH═CH₂ (i);

—C(O)-D₁-O—[(CH₂)_{y}—O]_{z}—C(O)—CH═CH₂ (ii);

—C(O)-D₂-O—[(CH₂)_{y}—O]_{z}—C(O)—CH═CH₂ (iii);

D₁ denotes a group of formula

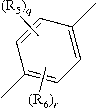

D₂ denotes a group of formula

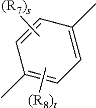

m, n, o, p, q, r, s, and t each independently denote 0, 1, or 2;
y denotes 0, 1, 2, 3, 4, 5, or 6;
z equals 0 if y equals 0 and z equals 1 if y equals 1 to 6.
In one aspect, the one or more chiral dopant compounds B may comprise one or more isomannide derivatives of formula (IA):

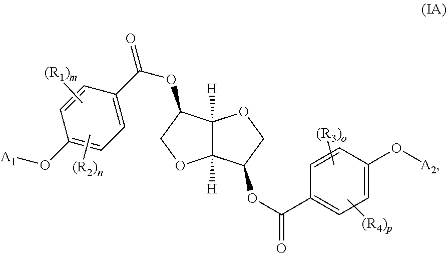

wherein:
R₁, R₂, R₃, R₄, R₅, R₆, R₇ and R₈ each independently denote C₁-C₆ alkyl and C₁-C₆ alkoxy;
A₁ and A₂ each independently denote a group of formula (i) to (iii):

—[(CH₂)y-O]z-C(O)—CH═CH₂ (i);

—C(O)-D₁-O—[(CH₂)y-O]z-C(O)—CH═CH₂ (ii);

—C(O)-D₂-O—[(CH₂)y-O]z-C(O)—CH═CH₂ (iii);

D₁ denotes a group of formula

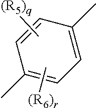

D₂ denotes a group of formula

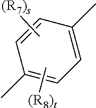

m, n, o, p, q, r, s, and t each independently denote 0, 1, or 2;
y denotes 0, 1, 2, 3, 4, 5, or 6;
z equals 0 if y equals 0 and z equals 1 if y equals 1 to 6.

In one embodiment of the compounds of formula (IA) (and of compounds of formula (I)), R₁, R₂, R₃, R₄, R₅, R₆, R₇ and R₈ each independently denote C₁-C₆ alkyl. In an alternative embodiment, R₁, R₂, R₃, R₄, R₅, R₆, R₇ and R₈ in formula (IA) (and in formula (I)) each independently denote C₁-C₆ alkoxy.

In another embodiment of the compounds of formula (I) and of formula (IA), A₁ and A₂ each independently denote a group of formula —[(CH₂)_{y}—O]_{z}—C(O)—CH═CH₂; R₁, R₂, R₃ and R₄ each independently denote C₁-C₆ alkyl; and m, n, o, and p each independently denote 0, 1, or 2. In yet another embodiment, A₁ and A₂ in formula (I) and formula (IA) each independently denote a group of formula —[(CH₂)_{y}—O]_{z}—C(O)—CH═CH₂; R₁, R₂, R₃ and R₄ each independently denote C₁-C₆ alkoxy; and m, n, o, and p each independently denote 0, 1, or 2.

In another embodiment of the compounds of formula (IA) (and of formula (I)), A₁ and A₂ each independently denote a group of formula —C(O)-D₁-O—[(CH₂)_{y}—O]_{z}—C(O)—CH═CH₂ and/or of formula —C(O)-D₂-O—[(CH₂)_{y}—O]_{z}—C(O)—CH═CH₂; and R₁, R₂, R₃, R₄, R₅, R₆, R₇ and R₅ each independently denote C₁-C₆ alkyl. In an alternative embodiment, A₁ and A₂ in formula (IA) (and in formula (I)) each independently denote a group of formula —C(O)-D₁-O—[(CH₂)_{y}—O]_{z}C(O)—CH═CH₂ and/or a group of formula —C(O)-D₂-O—[(CH₂)_{y}—O]_{z}—C(O)—CH═CH₂; and R₁, R₂, R₃, R₄, R₅, R₆, R₇ and R₈ each independently denote C₁-C₆ alkoxy.

In another aspect, the one or more chiral dopant compounds B may comprise one or more isosorbide derivatives represented by formula (IB):

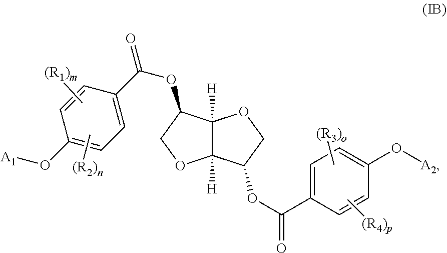

wherein:
R₁, R₂, R₃, R₄, R₅, R₆, R₇ and R₈ each independently denote C₁-C₆ alkyl and C₁-C₆ alkoxy;
A₁ and A₂ each independently denote a group of formula (i) to (iii):

—[(CH₂)y-O]z-C(O)—CH═CH₂ (i);

—C(O)-D₁-O—[(CH₂)y-O]z-C(O)—CH═CH₂ (ii);

—C(O)-D₂-O—[(CH₂)y-O]z-C(O)—CH═CH₂ (iii);

D₁ denotes a group of formula

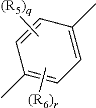

D₂ denotes a group of formula

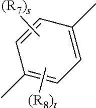

m, n, o, p, q, r, s, and t each independently denote 0, 1, or 2;
y denotes 0, 1, 2, 3, 4, 5, or 6;
z equals 0 if y equals 0 and z equals 1 if y equals 1 to 6.

In one embodiment of the compounds of formula (IB), R₁, R₂, R₃, R₄, R₅, R₆, R₇ and R₈ each independently denote C₁-C₆ alkyl. In an alternative embodiment, R₁, R₂, R₃, R₄, R₅, R₆, R₇ and R₈ in formula (IB) each independently denote C₁-C₆ alkoxy.

In another embodiment of the compounds of formula (IB), A₁ and A₂ each independently denote a group of formula —[(CH₂)_{y}—O], —C(O)—CH═CH₂; R₁, R₂, R₃ and R₄ each independently denote C₁-C₆ alkyl; and m, n, o, and p each independently denote 0, 1, or 2. In yet another embodiment, A₁ and A₂ in formula (IB) each independently denote a group of formula —[(CH₂)_{y}—O]_{z}—C(O)—CH═CH₂; R₁, R₂, R₃ and R₄ each independently denote C₁-C₆ alkoxy; and m, n, o, and p each independently denote 0, 1, or 2.

In another embodiment of the compounds of formula (IB), A₁ and A₂ each independently denote a group of formula —C(O)-Di-O—[(CH₂)_{y}—O]_{z}—C(O)—CH═CH₂ and/or of formula —C(O)-D₂-O—[(CH₂)_{y}—O]_{z}—C(O)—CH═CH₂; and R₁, R₂, R₃, R₄, R₅, R₆, R₇ and R₈ each independently denote C₁-C₆ alkyl. In an alternative embodiment, A₁ and A₂ in formula (IB) each independently denote a group of formula —C(O)-D₁-O—[(CH₂)_{y}—O]_{z}—C(O)—CH═CH₂ and/or a group of formula —C(O)-D₂-O—[(CH₂)_{y}—O], —C(O)—CH═CH₂; and R₁, R₂, R₃, R₄, R₅, R₆, R₇ and R₈ each independently denote C₁-C₆ alkoxy.

In a preferred embodiment, the alkyl and alkoxy groups of R₁, R₂, R₃, R₄, R₅, R₆, R₇ and R₈ in formulae (I), (IA) and (IB) may comprise 3, 4, 6 or 7 carbon atoms and in particular, 4 or 6 carbon atoms.

Examples of alkyl groups comprising 3 or 4 carbon atoms include isopropyl and butyl. Examples of alkyl groups comprising 6 or 7 carbon atoms include hexyl, 2-methylpentyl, 3-methylpentyl, 2,2-dimethylpentyl, and 2,3-dimethylpentyl.

Examples of alkoxy groups comprising 3 or 4 carbon atoms include isopropoxy, but-1-oxy, but-2-oxy, and tert-butoxy. Examples of alkoxy groups comprising 6 or 7 carbon atoms include hex-1-oxy, hex-2-oxy, hex-3-oxy, 2-methylpent-1-oxy, 2-methylpent-2-oxy, 2-methylpent-3-oxy, 2-methylpent-4-oxy, 4-methylpent-1-oxy, 3-methylpent-1-oxy, 3-methylpent-2-oxy, 3-methylpent-3-oxy, 2,2-dimethylpent-1-oxy, 2,2-dimethylpent-3-oxy, 2,2-dimethylpent-4-oxy, 4,4-dimethylpent-1-oxy, 2,3-dimethylpent-1-oxy, 2,3-dimethylpent-2-oxy, 2,3-dimethylpent-3-oxy, 2,3-dimethylpent-4-oxy, and 3,4-dimethylpent-1-oxy.

Non-limiting specific examples of chiral dopant compounds B of formula (I) for use in the present invention are provided in the Examples below.

The one or more chiral dopant compounds B will usually be present in a total concentration of from about 0.1% to about 30% by weight, e.g., from about 0.1% to about 25%, or from about 0.1% to about 20% by weight, based on the total weight of the composition. For example, in the case of inkjet printing the best results will often be obtained with concentrations of from 3% to 10% by weight, e.g., from 5% to 8% by weight, based on the total weight of the polymer composition. The one or more nematic compounds A will often be present in a concentration of from about 30% to about 50% by weight, based on the total weight of the polymer composition.

One component of the chiral liquid crystal precursor composition for use in the present invention is a salt and in particular, a salt that is capable of changing the position of the selective reflection band exhibited by the cured chiral liquid crystal precursor composition (in the chiral liquid crystal state) compared to the position of the selective reflection band exhibited by the cured composition without the salt. Regarding the selective reflection band exhibited by a chiral liquid crystal the explanations in U.S. Pat. No. 7,742,136 or US 20100025641, the entire disclosure of which is expressly incorporated by reference herein, may, for example, be referred to.

The extent to which the position of the selective reflection band exhibited by a given cured chiral liquid crystal precursor composition can be shifted by the presence of a salt depends on various factors such as, inter alia, the cation of the salt, the anion of the salt, and the concentration of the salt per gram of dry extract. In this regard, the Examples below may be referred to. Usually it is preferred for a salt to be present in a given chiral liquid crystal precursor at a concentration which shifts the position of the selective reflection band exhibited by a cured chiral liquid crystal precursor composition by at least about 5 nm, e.g., by at least about 10 nm, by at least about 20 nm, by at least about 30 nm, by at least about 40 nm, or by at least about 50 nm. Suitable (total) salt concentrations are often within the range of from about 0.01% to about 10% by weight, e.g., from about 0.1% to about 5% by weight, based on the solids content of the chiral liquid crystal precursor composition.

Non-limiting examples of suitable salts include salts which comprise a metal cation (main group metals, transition metals, lanthanides and actinides). For example, the metal may be an alkali or alkaline earth metal such as, e.g., Li, Na. Further non-limiting examples of suitable salts include quaternary ammonium salts such as tetraalkylammonium salts. Examples of suitable anions include “regular” ions such as, e.g., halide (e.g., fluoride, chloride, bromide, iodide), perchlorate, nitrate, nitrite, sulfate, sulfonate, sulfite, carbonate, bicarbonate, cyanide, cyanate, and thiocyanate, as well as complex ions such as, e.g., tetrafluoroborate. Of course, mixtures of two or more salts (e.g., two, three, four or more salts) may be used as well. If two or more salts are present, they may or may not comprise the same cation and/or the same anion.

The chiral liquid crystal precursor composition can be applied onto the surface of the auto-adhesive layer/film by any suitable method such as, for example, spray coating, knife coating, roller coating, screen coating, curtain coating, gravure printing, flexography, offset printing, dry offset printing, letterpress printing, screen-printing, pad printing, and ink-jet printing (for example continuous ink-jet printing, drop-on-demand ink-jet printing, valve-jet printing). In one of the embodiments of the present invention the application (e.g., deposition) of a composition for making the marking or layer and/or a composition for making the modifying resin is carried out with a printing technique such as, e.g., ink-jet printing (continuous, drop-on-demand, etc.), flexography, pad printing, rotogravure printing, screen-printing, etc. Of course, other printing techniques known by those of skill in the art of printing may be used as well. In one of the preferred embodiments of the invention flexography printing is employed both for applying the resin and for applying the chiral liquid crystal precursor composition. In another preferred embodiment of the invention, ink-jet printing techniques are used both for applying the modifying resin and for applying the chiral liquid crystal precursor composition. It is contemplated also that two different techniques can be used respectively to apply the modifying resin and the chiral liquid crystal precursor composition. The industrial ink-jet printers, commonly used for numbering, coding and marking applications on conditioning lines and printing presses, are particularly suitable. Preferred ink-jet printers include single nozzle continuous ink-jet printers (also called raster or multi-level deflected printers) and drop-on-demand ink-jet printers, in particular valve-jet printers. The thickness of the applied liquid crystal polymer composition, after curing, according to the above described application techniques, will usually be at least about 1 μm, e.g., at least about 3 μm, or at least about 4 μm, and will usually be not more than about 20 μm, e.g., not more than about 15 μm, not more than about 10 μm, or not more than about 6 μm. The thickness of the applied modifying resin, after curing, according to the above described application techniques will usually be at least about 1 μm, e.g., at least about 3 μm, or at least about 5 μm, but will usually be not more than about 10 μm.

In particular if a polymer composition for use in the present invention (i.e., a composition for making a chiral liquid crystal precursor or a composition for making a modifying resin) is to be applied by the printing techniques set forth above the composition will usually comprise a solvent to adjust its viscosity to a value which is suitable for the employed application (printing) technique. Typical viscosity values for flexographic printing inks are in the range of from about 40 seconds to about 120 seconds using e.g. a cup DIN number 4. Suitable solvents are known to those of skill in the art. Non-limiting examples thereof include low-viscosity, slightly polar and aprotic organic solvents, such as, e.g., methyl ethyl ketone (MEK), acetone, cyclohexanone, ethyl acetate, ethyl 3-ethoxypropionate, and mixtures of two or more thereof.

Further, in particular if a polymer composition for use in the present invention (i.e., a composition for making a chiral liquid crystal precursor or a composition for making a modifying resin) is to be applied by (continuous) ink-jet printing, the polymer composition will usually also comprise at least one conductivity agent known by those of skill in the art.

If a chiral liquid crystal precursor composition and/or a composition for making a modifying resin for use in the present invention is to be cured/polymerized by UV radiation the composition will also comprise at least one photoinitiator. Non-limiting examples of the many suitable photoinitiators include α-hydroxyketones such as 1-hydroxy-cyclohexyl-phenyl-ketone and a mixture (e.g., about 1:1) of 1-hydroxy-cyclohexyl-phenyl-ketone and one or more of benzophenone, 2-hydroxy-2-methyl-1-phenyl-1-propanone, and 2-hydroxy-1-[4-(2-hydroxyethoxy)phenyl]-2-methyl-1-propanone; phenylglyoxylates such as methylbenzoylformate and a mixture of oxy-phenyl-acetic acid 2-[2-oxo-2-phenyl-acetoxy-ethoxy]-ethyl ester and oxy-phenyl-acetic 2-[2-hydroxy-ethoxy]-ethyl ester; benzyldimethyl ketals such as alpha, alpha-dimethoxy-alpha-phenylacetophenone; α-aminoketones such as 2-benzyl-2-(dimethylamino)-1-[4-(4-morpholinyl)phenyl]-1-butanone and 2-methyl-1-[4-(methylthio)phenyl]-2-(4-morpholinyl)-1-propanone; phosphine oxide and phosphine oxide derivatives such as diphenyl (2,4,6-trimethylbenzoyl)-phosphine oxide; phenyl bis(2,4,6-trimethylbenzoyl) supplied by Ciba; and also thioxanthone derivatives such as Speedcure ITX (CAS 142770-42-1), Speedcure DETX (CAS 82799-44-8), Speedcure CPTX (CAS 5495-84-1-2 or CAS 83846-86-0) supplied by Lambson.

If a polymer composition for use in the present invention (i.e., a composition for making a chiral liquid crystal precursor or a composition for making a modifying resin) is to be cured by a method which is different from irradiation with UV light such as, e.g., by means of high-energy particles (e.g., electron beams), X-rays, gamma-rays, etc. the use of a photoinitiator can, of course, be dispensed with.

It may also be possible or even desirable to cure especially the composition for making a modifying resin thermally. In this case the composition will usually contain at least one thermal polymerization initiator such as, e.g., a peroxide or an azo compound. Other examples of thermal polymerization initiators are well known to those of skill in the art.

A salt-containing chiral liquid crystal precursor composition and a composition for providing a modifying resin for use in the present invention may also comprise a variety of other optional components which are suitable and/or desirable for achieving a particular desired property of the composition and in general, may comprise any components/substances which do not adversely affect a required property of the composition to any significant extent. Non-limiting examples of such optional components are resins, silane compounds, adhesion promoters, sensitizers for the photoinitators (if present), etc. For example, especially a chiral liquid crystal precursor composition for use in the present invention may comprise one or more silane compounds. Non-limiting examples of suitable silane compounds include optionally polymerizable silanes such as those of formula R₁R₂R₃—Si—R₄ wherein R₁, R₂, and R₃ independently represent alkoxy and alkoxyalkoxy having a total of from 1 to about 6 carbon atoms and R₄ represents vinyl, allyl, (C₁₋₁₀)alkyl, (meth)acryloxy(C₁₋₆)alkyl, and glycidyloxy(C₁₋₆)alkyl such as, e.g., vinyltriethoxysilane, vinyltrimethoxysilane, vinyltris(2-methoxyethoxy)silane, 3-methacryloxypropyl-trimethoxysilane, octyltriethoxysilane, and 3-glycidyloxypropyl triethoxysilane from the Dynasylan® family supplied by Evonik.

The concentration of the one or more silane compounds, if present, in the liquid crystal precursor composition will usually be from about 0.5% to about 5% by weight, based on the total weight of the composition.

In order to strengthen the security of the marking or layer according to the present invention a composition for making a modifying resin and/or a composition for making a chiral liquid crystal precursor for use in the present invention may further comprise one or more pigments and/or dyes which absorb in the visible or invisible region of the electromagnetic spectrum and/or one or more pigments and/or dyes which are luminescent and/or one or more magnetic pigments. Non-limiting examples of suitable pigments and/or dyes which absorb in the visible or invisible region of the electromagnetic spectrum include phthalocyanine derivatives. Non-limiting examples of suitable luminescent pigments and/or dyes include lanthanide derivatives. Non-limiting examples of suitable magnetic pigments include particles of transitional metal oxides such as iron and chromium oxides. The presence of pigment(s) and/or dye(s) will enhance and reinforce the security of the marking against counterfeiting. According to the marking of the present invention, if the resin and/or the liquid crystal polymer layer contain such pigments and/or dyes, the wavelength of absorption or emission of these pigments and/or dyes will be chosen different from the ones of the distribution of flakes overlapping the code. It will be thus possible to have a very complex multiple signature hard to forge or to reproduce by counterfeiters.

Following the application (e.g., deposition) of the salt-containing chiral liquid crystal precursor composition onto the substrate, the polymer composition is brought to a chiral liquid crystal state having specific optical properties. The term “specific optical properties” is to be understood as a liquid crystal state with a specific pitch that reflects a specific wavelength range (selective reflection band). To that end the chiral liquid crystal precursor composition is heated, the solvent contained in the composition, if present, is evaporated and the promotion of the desired chiral liquid crystal state takes place. The temperature used to evaporate the solvent and to promote the formation of the liquid crystal state depends on the components of the chiral liquid crystal precursor composition and will in many cases range from about 55° C. to about 150° C., e.g., from about 55° C. to about 100° C., preferably from about 60° C. to about 100° C. Examples of suitable heating sources include conventional heating means such as a hot plate, an oven, a stream of hot air and in particular, radiation sources such as, e.g., an IR lamp. The required heating time depends on several factors such as, e.g., the components of the polymer composition, the type of heating device and the intensity of the heating (energy output of the heating device). In many cases a heating time of from about 0.1 s, about 0.5 s, or about 1 second to about 30 seconds such as, e.g., not more than about 20 seconds, not more than about 10 seconds, or not more than about 5 seconds will be sufficient.

The marking according to the present invention is finally obtained by curing and/or polymerizing the (entire) composition in the chiral liquid crystal state. The fixing or hardening will often be performed by irradiation with UV-light, which induces polymerization of the polymerizable groups present in the polymer composition.

Accordingly, an entire process for making a marking of the present invention may comprise the following steps:

Printing a mono and/or a bidimensional code on a substrate;

Applying a modifying resin comprising a distribution of flakes onto an auto-adhesive layer/film;

Curing and/or drying the applied modifying resin at least partially, for instance fully;

Applying a salt-containing liquid crystal precursor composition onto a portion of the auto-adhesive intermediate layer that has the modifying resin thereon;

Heating the applied liquid crystal precursor composition to bring it to the cholesteric state;

Curing the heated liquid crystal precursor composition (and optionally, completing the curing and/or drying of the modifying resin) so as to obtain a CLCP coating layer,

Applying the auto-adhesive layer/film onto the code of the substrate.

Accordingly, in a preferred embodiment, a process for making a marking of the present invention may comprise the following steps:

Printing a first mono or bidimensional code on a substrate and a second mono or bidimensional code on the substrate, the second code being adjacent to the first code;

Applying a first and a second modifying resin comprising a distribution of flakes onto an auto-adhesive layer/film, the first modifying resin being adjacent to the second modifying resin;

Curing and/or drying the applied modifying resins at least partially, for instance fully;

Applying a salt-containing liquid crystal precursor composition onto a portion of the auto-adhesive intermediate layer that has the modifying resins thereon;

Heating the applied liquid crystal precursor composition to bring it to the cholesteric state;

Curing the heated liquid crystal precursor composition (and optionally, completing the curing and/or drying of the modifying resin) so as to obtain a CLCP coating layer,

Applying the auto-adhesive layer/film onto the two codes of the substrate, so that the first code is overlapped by the first modifying resin and the second code is overlapped by the second modifying resin.

In particular, the first and the second modifying resins may be the same or different, and may comprise the same or different flakes.

The marking according to the present invention, incorporated over an item or good or a packaging as a security feature, is also useful as an authenticity feature, an identification feature or a tracking and tracing feature.

The following examples are intended to illustrate the invention without restricting it.

### Example

FIG. 1 shows the first step of a method of producing a void tamper evidence label 1 comprising a distribution of flakes, according to the invention. The first step comprises providing an auto-adhesive layer 2, and depositing a distribution of flakes 3 on it. In particular, it is considered that the distribution of flakes 3 is included into a specific binder, a modifying resin 4. The void tamper evidence label 1 can also comprise another modifying resin 5, without the distribution of flakes, the same or different from the modifying resin 4 comprising the distribution of flakes 3.

The auto-adhesive label layer 2 can be a commercially available auto-adhesive label, as for example reference RI-647/23 PET gloss clear produced by Ritrama, or a commercially available void tamper evidence label provided by Schreiner company, and is used as intermediate layer. The intermediate layer is a substrate for the modifying resin 4 comprising the distribution of flakes 3 and for the modifying resin 5.

The following composition for preparing a UV cured modifying resin 4 were prepared (in % by weight, based on the total weight of the composition):

Composition (II):

| | | |
|---|---|---|
| 4% | Acryloy morpholine | Reactive monomer |
| 38% | Genocure 5275 | Reactive Oligomer |
| 29% | Ebecryl 80 | Reactive Oligomer |
| 10% | Ebecryl 83 | Reactive Oligomer |
| 10% | TPGDA | Reactive monomer |
| 4% | Irgacure 907 | Photoinitiator |
| 2% | Tego Airex 920 | Deaerator additive |
| 3% | Helicone HC Jade | LCP flakes |

(Ebecryl 83 is a low viscosity amine modified multifunctional acrylate)

The modifying resin 4 comprising the distribution of CLCP flakes 3 is screen printed in a shape of a logo on the auto-adhesive label layer 2 (FIG. 1), and then UV cured using the mini 18-2 Aktiprint UV dryer available from Technigraf set at 100% of the maximum speed. The final thickness of the cured varnish is approximately 18 μm.

### Preparation of a Chiral Liquid Crystal Precursor Composition

A chiral liquid crystal precursor composition (I) was prepared as follows, the indicated percentages being by weight based on the total weight of the composition:

A chiral dopant compound B of formula (I) shown above (6%), a nematic compound A (35%), and cyclohexanone (57.6%) were placed into a flask which was thereafter heated until a solution was obtained. To the solution were added 2-methyl-1 [4-(methylthio)phenyl]-2-morpholinopropan-1-one (Irgacure 907® from Ciba, photoinitiator, 0.8%), a leveling agent (TEGO rad 2010, 0.1%) and a salt (LiClO₄, 0.5%). The final mixture was stirred until complete dissolution was achieved to result in the chiral liquid crystal precursor composition (I).

The liquid crystal precursor composition 6 is coated all over the pre-printed auto-adhesive label layer 2 (FIG. 2), using drawdown bare no 1 which applies about 6 μm of wet film. The salt-containing CLCP precursor composition 6 covers the auto-adhesive layer 2 and the modifying resins 4 and 5.

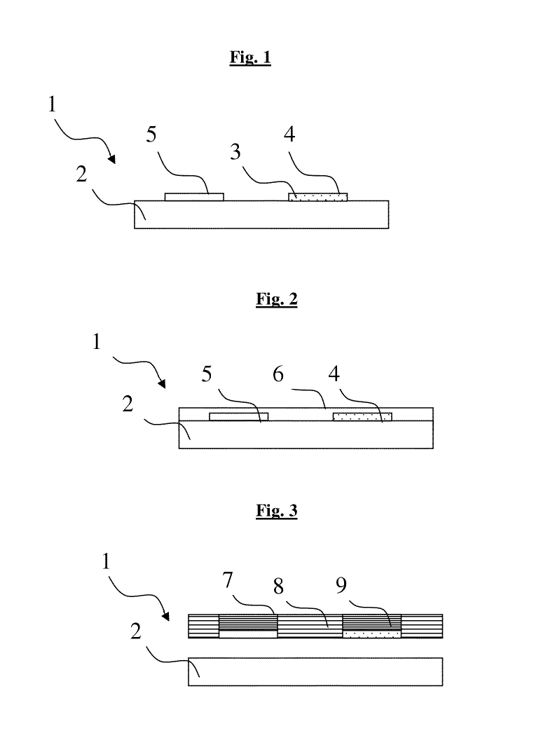

The resultant layer is rapidly placed on a heating plate to be heated at about 80° C. for about 30 seconds, so as to evaporate the solvent and to develop a salt-containing CLCP coating layer 7 having a cholesteric liquid crystal phase, i.e., a state that shows a specific reflection band whose position depends on the concentration of the chiral dopant compound B in the composition. Thereafter the composition was UV cured using mini 18-2 Aktiprint UV dryer available from Technigraf set at 100% of the maximum speed, to freeze the cholesteric liquid crystal phase through co-polymerization of the polymerizable groups of compounds A and B (FIG. 3).

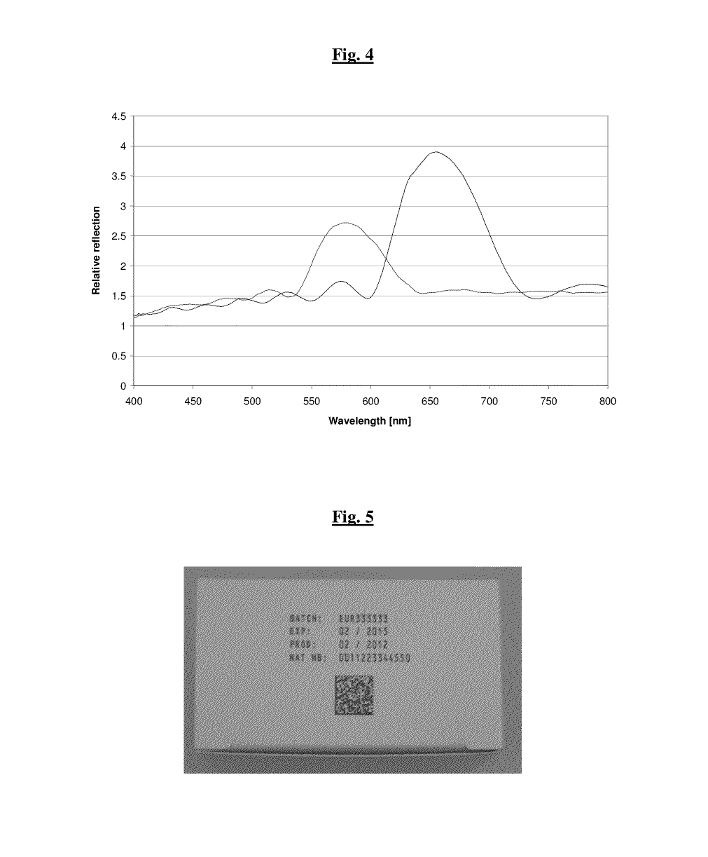

FIG. 4 shows two reflection spectra of the sample measured using an analytical spectral device in the infrared-near-infrared-visible-UV range of the spectrum, such as the LabSpec Pro device made by Analytical Spectral Devices Inc. of Boulder, Colo. One first spectrum is taken on an area 8 where the liquid crystal polymer coating layer 7 is in contact with the auto-adhesive layer surface 2, the second spectrum is taken on an area 9 where the liquid crystal polymer coating layer 7 is in contact with the screen printed modifying resin surface 4 (or 5). As the varnish modifies λₘₐₓ the two spectrum show different λₘₐₓ. Thus, the CLCP coating layer 7 does not develop the same colour shift property depending on whether it is in contact with the auto-adhesive label layer 2 or with the modifying resin 4 (or 5).

The addition of salt to a chiral liquid crystal precursor composition can be used to shift the position of the selective reflection band of the corresponding cured polymer in a controllable manner and both the type of salt and the concentration thereof can influence the shifting effect of a salt (in addition to the changing of the concentration of the chiral dopant). The shifting effect of the salt can be partly or completely reversed (in a controllable manner) by contacting the chiral liquid crystal precursor composition with a cured (acrylate) resin before curing the liquid crystal precursor.

The following compounds may, for example, be employed in the above Examples as chiral dopant compound B of formula (I):
(3R,3aR,6R,6aR)-hexahydrofuro[3,2-b]furan-3,6-diyl bis(4-(4-(acryloyloxy)-3-methoxybenzoyloxy)-3-methoxybenzoate);
(3R,3aR,6R,6aR)-6-(4-(4-(acryloyloxy)-3-methoxybenzoyloxy)-3-methoxybenzoyloxy)-hexahydrofuro[3,2-b]furan-3-yl 4-(4-(acryloyloxy)benzoyloxy)-3-methoxybenzoate;
(3R,3aR,6R,6aR)-hexahydrofuro[3,2-b]furan-3,6-diyl bis(4-(4(acryloyloxy)benzoyloxy)-benzoate);
(3R,3aR,6R,6aR)-hexahydrofuro[3,2-b]furan-3,6-diyl bis(4-(4-(acryloyloxy)butoxy)-benzoate);
(3R,3 aR,6R,6aR)-hexahydrofuro[3,2-b]furan-3,6-diyl bis(4-(acryloyloxy)-2-methylbenzoate);
(3R,3aR,6S,6aR)-hexahydrofuro[3,2-b]furan-3,6-diyl bis(4-(4-(acryloyloxy)benzoyloxy)-3-methoxybenzoate);
(3R,3 aR,6R,6aR)-hexahydrofuro[3,2-b]furan-3,6-diyl bis(4-(4-(acryloyloxy)-3-methoxy-benzoyloxy)benzoate);
(3R,3aR,6R,6aR)-hexahydrofuro[3,2-b]furan-3,6-diyl bis(4-(4(acryloyloxy)benzoyloxy)-3-methoxybenzoate);
2-O-(4-{[4-(acryloyloxy)benzoyl]oxy}-2-methoxybenzoyl)-5-O-(4-{[4-(acryloyloxy)-benzoyl]oxy}-3-methoxybenzoyl)-1,4:3,6-dianhydro-D-mannitol;
2,5-bis-O-(4-{[4-(acryloyloxy)benzoyl]oxy}-2-methoxybenzoyl)-1,4:3,6-dianhydro-D-manntol;
2-O-(4-{[4-(acryloyloxy)benzoyl]oxy}-2-methoxybenzoyl)-5-O-(4-{[4-(acryloyloxy)-2-methylbenzoyl]oxy}-2-methoxybenzoyl)-1,4:3,6-dianhydro-D-mannitol;
2-O-(4-{[4-(acryloyloxy)benzoyl]oxy}-2-methoxybenzoyl)-5-O-(4-{[4-(acryloyloxy)-3-methylbenzoyl]oxy}-2-methoxybenzoyl)-1,4:3,6-dianhydro-D-mannitol
2-O-(4-{[4-(acryloyloxy)benzoyl]oxy}-2-methoxybenzoyl)-5-O-(4-{[4-(acryloyloxy)-3-methylbenzoyl]oxy}-2-methoxybenzoyl)-1,4:3,6-dianhydro-D-mannitol;
2-O-(4-{[4-(acryloyloxy)benzoyl]oxy}-2-methoxybenzoyl)-5-O-(4-{[4-(acryloyloxy)-2,5-dimethylbenzoyl]oxy}-2-methoxybenzoyl)-1,4:3,6-dianhydro-D-mannitol;
2-O-(4-{[4-(acryloyloxy)-2,5-dimethylbenzoyl]oxy}-2-methoxybenzoyl)-5-O-(4-{[4-(acryloyloxy)-3-methylbenzoyl]oxy}-2-methoxybenzoyl)-1,4:3,6-dianhydro-D-mannitol
2-O-(4-{[4-(acryloyloxy)-2-methoxy-5-methylbenzoyl]oxy}-2-methoxybenzoyl)-5-O-(4-{[4-(acryloyloxy)-3-methylbenzoyl]oxy}-2-methoxybenzoyl)-1,4:3,6-dianhydro-D-mannitol;
2-O-(4-{[4-(acryloyloxy)-2-methoxybenzoyl]oxy}-2-methoxybenzoyl)-5-O-(4-{[4-(acryloyloxy)-3-methylbenzoyl]oxy}-2-methoxybenzoyl)-1,4:3,6-dianhydro-D-mannitol;
2-O-(4-{[4-(acryloyloxy)-2-methoxybenzoyl]oxy}-2-methoxybenzoyl)-5-O-(4-{[4-(acryloyloxy)-3-methoxybenzoyl]oxy}-2-methoxybenzoyl)-1,4:3,6-dianhydro-D-mannitol;
2-O-(4-{[4-(acryloyloxy)-2-methoxybenzoyl]oxy}benzoyl)-5-O-(4-{[4-(acryloyloxy)-3-methoxybenzoyl]oxy}benzoyl)-1,4:3,6-dianhydro-D-mannitol;
2,5-bis-O-(4-{[4-(acryloyloxy)benzoyl]oxy}-3-methoxybenzoyl)-1,4:3,6-dianhydro-D-mannitol;
2-O-(4-{[4-(acryloyloxy)-2-methoxybenzoyl]oxy}-2,5-dimethylbenzoyl)-5-O-(4-{[4-(acryloyloxy)-3-methoxybenzoyl]oxy}-3-methylbenzoyl)-1,4:3,6-dianhydro-D-mannitol;
2-O-(4-{[4-(acryloyloxy)-2-methoxybenzoyl]oxy}-2-methylbenzoyl)-5-O-(4-{[4-(acryloyloxy)-3-methoxybenzoyl]oxy}-3-methylbenzoyl)-1,4:3,6-dianhydro-D-mannitol;
2-O-(4-{[4-(acryloyloxy)-2-methoxy-5-methylbenzoyl]oxy}-2-methylbenzoyl)-5-O-(4-{[4-(acryloyloxy)-5-methoxy-2-methylbenzoyl]oxy}-3-methylbenzoyl)-1,4:3,6-dianhydro-D-mannitol;
2-O-(4-{[4-(acryloyloxy)benzoyl]oxy}-2-ethoxybenzoyl)-5-O-(4-{[4-(acryloyloxy)-3-ethoxybenzoyl]oxy}benzoyl)-1,4:3,6-dianhydro-D-mannitol;
2-O-(4-{[4-(acryloyloxy)benzoyl]oxy}-2-ethoxy-5-methylbenzoyl)-5-O-(4-{[4-(acryloyloxy)-3-ethoxybenzoyl]oxy}benzoyl)-1,4:3,6-dianhydro-D-mannitol;
2-O-(4-{[4-(acryloyloxy)benzoyl]oxy}-2-ethoxy-5-methylbenzoyl)-5-O-(4-{[4-(acryloyloxy)-5-ethoxy-2-methylbenzoyl]oxy}benzoyl)-1,4:3,6-dianhydro-D-mannitol;
2-O-(4-{[4-(acryloyloxy)-3-ethoxybenzoyl]oxy}benzoyl)-5-O-(4-{[4-(acryloyloxy)-2-methylbenzoyl]oxy}-2-ethoxybenzoyl)-1,4:3,6-dianhydro-D-mannitol;
2-O-(4-{[4-(acryloyloxy)-2,5-dimethylbenzoyl]oxy}-2-ethoxybenzoyl)-5-O-(4-{[4-(acryloyloxy)-2-methylbenzoyl]oxy}-2-ethoxybenzoyl)-1,4:3,6-dianhydro-D-mannitol;
2,5-bis-O-(4-{[4-(acryloyloxy)-2,5-dimethylbenzoyl]oxy}-2-ethoxybenzoyl)-1,4:3,6-dianhydro-D-mannitol;
2,5-bis-O-(4-{[4-(acryloyloxy)-2-ethoxybenzoyl]oxy}-2-ethoxybenzoyl)-1,4:3,6-dianhydro-D-mannitol;
2,5-bis-O-(4-{[4-(acryloyloxy)-2-methoxybenzoyl]oxy}-2-ethoxybenzoyl)-1,4:3,6-dianhydro-D-mannitol;
2,5-bis-O-(4-{[4-(acryloyloxy)-2-ethoxybenzoyl]oxy}-2-methoxybenzoyl)-1,4:3,6-dianhydro-D-mannitol;
2,5-bis-O-(4-{[4-(acryloyloxy)-2-ethoxybenzoyl]oxy}-3-methylbenzoyl)-1,4:3,6-dianhydro-D-mannitol;
2,5-bis-O-(4-{[4-(acryloyloxy)-2-ethoxybenzoyl]oxy}-3-methoxybenzoyl)-1,4:3,6-dianhydro-D-mannitol;
2,5-bis-O-(4-{[4-(acryloyloxy)-3-methoxybenzoyl]oxy}-3-methoxybenzoyl)-1,4:3,6-dianhydro-D-mannitol;
2,5-bis-O-(4-{[4-(acryloyloxy)-3-methoxybenzoyl]oxy}-3-methoxybenzoyl)-1,4:3,6-dianhydro-D-glucitol;
2-O-(4-{[4-(acryloyloxy)benzoyl]oxy}-2-methoxybenzoyl)-5-O-(4-{[4-(acryloyloxy)-benzoyl]oxy}-3-methoxybenzoyl)-1,4:3,6-dianhydro-D-glucitol;
2,5-bis-O-(4-{[4-(acryloyloxy)benzoyl]oxy}-2-methoxybenzoyl)-1,4:3,6-dianhydro-D-glucitol;
2-O-(4-{[4-(acryloyloxy)benzoyl]oxy}-2-methoxybenzoyl)-5-O-(4-{[4-(acryloyloxy)-2-methylbenzoyl]oxy}-2-methoxybenzoyl)-1,4:3,6-dianhydro-D-glucitol;
2-O-(4-{[4-(acryloyloxy)benzoyl]oxy}-2-methoxybenzoyl)-5-O-(4-{[4-(acryloyloxy)-3-methylbenzoyl]oxy}-2-methoxybenzoyl)-1,4:3,6-dianhydro-D-glucitol;
2-O-(4-{[4-(acryloyloxy)benzoyl]oxy}-2-methoxybenzoyl)-5-O-(4-{[4-(acryloyloxy)-3-methylbenzoyl]oxy}-2-methoxybenzoyl)-1,4:3,6-dianhydro-D-glucitol;
2-O-(4-{[4-(acryloyloxy)benzoyl]oxy}-2-methoxybenzoyl)-5-O-(4-{[4-(acryloyloxy)-2,5-dimethylbenzoyl]oxy}-2-methoxybenzoyl)-1,4:3,6-dianhydro-D-glucitol;
2-O-(4-{[4-(acryloyloxy)-2,5-dimethylbenzoyl]oxy}-2-methoxybenzoyl)-5-O-(4-{[4-(acryloyloxy)-3-methylbenzoyl]oxy}-2-methoxybenzoyl)-1,4:3,6-dianhydro-D-glucitol;
2-O-(4-{[4-(acryloyloxy)-2-methoxy-5-methylbenzoyl]oxy}-2-methoxybenzoyl)-5-O-(4-{[4-(acryloyloxy)-3-methylbenzoyl]oxy}-2-methoxybenzoyl)-1,4:3,6-dianhydro-D-glucitol;
2-O-(4-{[4-(acryloyloxy)-2-methoxybenzoyl]oxy}-2-methoxybenzoyl)-5-O-(4-{[4-(acryloyloxy)-3-methylbenzoyl]oxy}-2-methoxybenzoyl)-1,4:3,6-dianhydro-D-glucitol;
2,5-bis-O-(4-{[4-(acryloyloxy)benzoyl]oxy}-3-methoxybenzoyl)-1,4:3,6-dianhydro-D)-glucitol;
2-O-(4-{[4-(acryloyloxy)-2-methoxybenzoyl]oxy}-2-methoxybenzoyl)-5-O-(4-{[4-(acryloyloxy)-3-methoxybenzoyl]oxy}-2-methoxybenzoyl)-1,4:3,6-dianhydro-D-glucitol;
2-O-(4-{[4-(acryloyloxy)-2-methoxybenzoyl]oxy}benzoyl)-5-O-(4-{[4-(acryloyloxy)-3-methoxybenzoyl]oxy}benzoyl)-1,4:3,6-dianhydro-D-glucitol;
2-O-(4-{[4-(acryloyloxy)-2-methoxybenzoyl]oxy}-2,5-dimethylbenzoyl)-5-O-(4-{[4-(acryloyloxy)-3-methoxybenzoyl]oxy}-3-methylbenzoyl)-1,4:3,6-dianhydro-D-glucitol;
2-O-(4-{[4-(acryloyloxy)-2-methoxybenzoyl]oxy}-2-methylbenzoyl)-5-O-(4-{[4-(acryloyloxy)-3-methoxybenzoyl]oxy}-3-methylbenzoyl)-1,4:3,6-dianhydro-D-glucitol;
2-O-(4-{[4-(acryloyloxy)-2-methoxy-5-methylbenzoyl]oxy}-2-methylbenzoyl)-5-O-(4-{[4-(acryloyloxy)-5-methoxy-2-methylbenzoyl]oxy}-3-methylbenzoyl)-1,4:3,6-dianhydro-D-glucitol;
2-O-(4-{[4-(acryloyloxy)benzoyl]oxy}-2-ethoxybenzoyl)-5-O-(4-{[4-(acryloyloxy)-3-ethoxybenzoyl]oxy}benzoyl)-1,4:3,6-dianhydro-D-glucitol;
2-O-(4-{[4-(acryloyloxy)benzoyl]oxy}-2-ethoxy-5-methylbenzoyl)-5-O-(4-{[4-(acryloyloxy)-3-ethoxybenzoyl]oxy}benzoyl)-1,4:3,6-dianhydro-D-glucitol;
2-O-(4-{[4-(acryloyloxy)benzoyl]oxy}-2-ethoxy-5-methylbenzoyl)-5-O-(4-{[4-(acryloyloxy)-5-ethoxy-2-methylbenzoyl]oxy}benzoyl)-1,4:3,6-dianhydro-D-glucitol
2-O-(4-{[4-(acryloyloxy)-3-ethoxybenzoyl]oxy}benzoyl)-5-O-(4-{[4-(acryloyloxy)-2-methylbenzoyl]oxy}-2-ethoxybenzoyl)-1,4:3,6-dianhydro-D-glucitol;
2-O-(4-{[4-(acryloyloxy)-2,5-dimethylbenzoyl]oxy}-2-ethoxybenzoyl)-5-O-(4-{[4-(acryloyloxy)-2-methylbenzoyl]oxy}-2-ethoxybenzoyl)-1,4:3,6-dianhydro-D-glucitol
2,5-bis-O-(4-{[4-(acryloyloxy)-2,5-dimethylbenzoyl]oxy}-2-ethoxybenzoyl)-1,4:3,6-dianhydro-D-glucitol;
2,5-bis-O-(4-{[4-(acryloyloxy)-2-ethoxybenzoyl]oxy}-2-ethoxybenzoyl)-1,4:3,6-dianhydro-D-glucitol;
2,5-bis-O-(4-{[4-(acryloyloxy)-2-methoxybenzoyl]oxy}-2-ethoxybenzoyl)-1,4:3,6-dianhydro-D-glucitol;
2,5-bis-O-(4-{[4-(acryloyloxy)-2-ethoxybenzoyl]oxy}-2-methoxybenzoyl)-1,4:3,6-dianhydro-D-glucitol;
2,5-bis-O-(4-{[4-(acryloyloxy)-2-ethoxybenzoyl]oxy}-3-methylbenzoyl)-1,4:3,6-dianhydro-D-glucitol; and
2,5-bis-O-(4-{[4-(acryloyloxy)-2-ethoxybenzoyl]oxy}-3-methoxybenzoyl)-1,4:3,6-dianhydro-D-glucitol.

As nematic compound A in the above Example, the following compounds may, for example, be employed:
benzoic acid, 4-[[[4-[(1-oxo-2-propen-1-yl)oxy]butoxy]carbonyl]oxy]-1,1′-(2-methyl-1,4-phenylene)ester;
2-methoxybenzene-1,4-diyl bis[4-({[4-(acryloyloxy)butoxy]carbonyl}oxy)benzoate];
4-{[4-({[4-(acryloyloxy)butoxy]carbonyl}oxy)benzoyl]oxy}-2-methoxyphenyl 4-({[4-(acryloyloxy)butoxy]carbonyl}oxy)-2-methylbenzoate;
2-methoxybenzene-1,4-diyl bis[4-({[4-(acryloyloxy)butoxy]carbonyl}oxy)-2-methylbenzoate];
2-methylbenzene-1,4-diyl bis[4-({[4-(acryloyloxy)butoxy]carbonyl}oxy)-2-methylbenzoate];
4-{[4-({[4-(acryloyloxy)butoxy]carbonyl}oxy)benzoyl]oxy}-2-methylphenyl 4-({[4-(acryloyloxy)butoxy]carbonyl}oxy)-3-methoxybenzoate;
2-methylbenzene-1,4-diyl bis[4-({[4-(acryloyloxy)butoxy]carbonyl}oxy)benzoate];
2-methylbenzene-1,4-diyl bis[4-({[4-(acryloyloxy)butoxy]carbonyl}oxy)-3-methoxybenzoate];
4-{[4-({[4-(acryloyloxy)butoxy]carbonyl}oxy)-3-methoxybenzoyl]oxy}-2-methylphenyl 4-({[4-(acryloyloxy)butoxy]carbonyl}oxy)-3,5-dimethoxybenzoate;
2-methylbenzene-1,4-diyl bis[4-({[4-(acryloyloxy)butoxy]carbonyl}oxy)-3,5-dimethoxybenzoate];
2-methoxybenzene-1,4-diyl bis[4-({[4-(acryloyloxy)butoxy]carbonyl}oxy)-3,5-dimethoxybenzoate]; and
4-{[4-({[4-(acryloyloxy)butoxy]carbonyl}oxy)-3-methoxybenzoyl]oxy}-2-methoxyphenyl 4-({[4-(acryloyloxy)butoxy]carbonyl}oxy)-3,5-dimethoxybenzoate.
   As nematic compound A in the above Examples the following compounds may, for example, be employed:
2-methyl-1,4-phenylene bis(4-(4-(acryloyloxy)butoxy)-benzoate);
4-({4-[4-(acryloyloxy)butoxy]benzoyl}oxy)-3-methylphenyl 4-[4-(acryloyloxy)butoxy]-2-methylbenzoate;
4-({4-[4-(acryloyloxy)butoxy]benzoyl}oxy)-3-methylphenyl 4-[4-(acryloyloxy)butoxy]-3-methylbenzoate;
2-methylbenzene-1,4-diyl bis{4-[4-(acryloyloxy)butoxy]-2-methylbenzoate};
4-({4-[4-(acryloyloxy)butoxy]-2-methylbenzoyl}oxy)-3-methylphenyl 4-[4-(acryloyloxy)butoxy]-2,5-dimethylbenzoate;
2-methylbenzene-1,4-diyl bis{4-[4-(acryloyloxy)butoxy]-2,5-dimethylbenzoate}
2-methylbenzene-1,4-diyl bis{4-[4-(acryloyloxy)butoxy]benzoate};
4-({4-[4-(acryloyloxy)butoxy]-3,5-dimethylbenzoyl}oxy)-3-methylphenyl 4-[4-(acryloyloxy)butoxy]-2,5-dimethylbenzoate;
2-methylbenzene-1,4-diyl bis{4-[4-(acryloyloxy)butoxy]-3,5-dimethylbenzoate};
2-methoxybenzene-1,4-diyl bis{4-[4-(acryloyloxy)butoxy]-3,5-dimethylbenzoate};
4-({4-[4-(acryloyloxy)butoxy]-3-methylbenzoyl}oxy)-2-methoxyphenyl 4-[4-(acryloyloxy)butoxy]-3,5-dimethylbenzoate;
2-methoxybenzene-1,4-diyl bis{4-[4-(acryloyloxy)butoxy]-3-methylbenzoate};
4-({4-[4-(acryloyloxy)butoxy]benzoyl}oxy)-3-methoxyphenyl 4-[4-(acryloyloxy)-butoxy]-3-methylbenzoate;
4-({4-[4-(acryloyloxy)butoxy]benzoyl}oxy)-3-methoxyphenyl 4-[4-(acryloyloxy)-butoxy]-2,5-dimethylbenzoate;
2-methoxybenzene-1,4-diyl bis{4-[4-(acryloyloxy)butoxy]-2-methoxybenzoate};
2-methoxybenzene-1,4-diyl bis{4-[4-(acryloyloxy)butoxy]-3,5-dimethoxybenzoate};
2-methoxybenzene-1,4-diyl bis{4-[4-(acryloyloxy)butoxy]-3-methoxybenzoate};
2-ethoxybenzene-1,4-diyl bis{4-[4-(acryloyloxy)butoxy]benzoate};
2-ethoxybenzene-1,4-diyl bis{4-[4-(acryloyloxy)butoxy]-2-methylbenzoate};
2-(propan-2-yloxy)benzene-1,4-diyl bis{4-[4-(acryloyloxy)butoxy]benzoate};
4-({4-[4-(acryloyloxy)butoxy]benzoyl}oxy)-2-(propan-2-yloxy)phenyl 4-[4-(acryloyloxy)butoxy]-2-methylbenzoate;
2-(propan-2-yloxy)benzene-1,4-diyl bis{4-[4-(acryloyloxy)butoxy]-2-methylbenzoate};
2-(propan-2-yloxy)benzene-1,4-diyl bis{4-[4-(acryloyloxy)butoxy]-2,5-dimethylbenzoate};
2-(propan-2-yloxy)benzene-1,4-diyl bis{4-[4-(acryloyloxy)butoxy]-3,5-dimethylbenzoate}; and
2-(propan-2-yloxy)benzene-1,4-diyl bis{4-[4-(acryloyloxy)butoxy]-3,5-dimethoxybenzoate}.

FIG. 5 shows an item on which the tamper proof can be applied. The item can be identified by reading the datamatrix printed on it using conventional datamatrix reader. The datamatrix contains specific informations related to the item, as for example a batch number, and is printed on the item with conventional black ink-jet ink using common thermal ink-jet technology as developed by HP. Other printing techniques known by the skilled in the art could also be used to print the datamatrix.

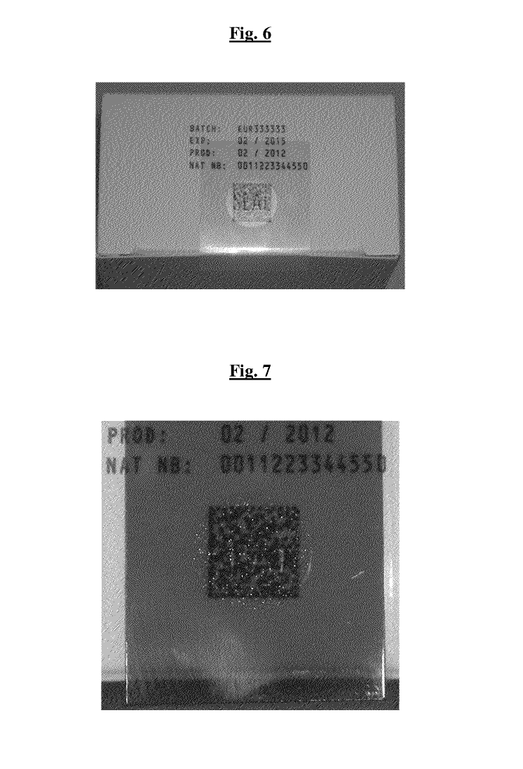

The tamper proof label 1 is affixed on the item in such a way that the modifying resin comprising the distribution of CLCP flakes at least partially overlaps the datamatrix printed on the item (FIG. 6). The distribution of flakes 3 can easily be detected with a polarized filter (FIG. 7).

The specific position of the randomly distributed LCP flakes according to the datamatrix is a specific identifier of the position of the whole label according to the item itself. If the label is removed and repositioned on the item, the change in the relative position of the randomly distributed LCP flakes according to the datamatrix will be easily detected leading to the conclusion that the item has been tampered.

It should be noted that, even though altered codes (for instance datamatrix covered with small particles or tubes or fibers or lines) are merely impossible to read (due to the fact that pixel of the datamatrix will be unreadable and then affects the readability of the code), the presence of CLCP flakes which are transparent or which are visible only with specific wavelengths and/or polarisation, above the codes allows both the easy reading of the code and also the easy detection of the flakes. Therefore, the marking according to the present invention allows to increase the security of the item, without impairing the reading of the code.

Moreover, the codes are preferably prepared from materials that are readable at wavelengths at which the flakes are invisible. For example, the datamatrix can be printed with an ink that is readable in the IR range, whereas the flakes are invisible in the IR range. In this manner, the datamatrix can be read by light in the IR range without possible interference by flakes overlapping with the datamatrix.

Still further, any number of markings can be included with an item or good, such as one marking, two markings, or any number of markings greater than two markings.

It is noted that the foregoing example has been provided merely for the purpose of explanation and is in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. An auto-adhesive marking member comprising, in the following order and in at least a partially overlapping relationship:
(a) a layer comprising a label stock layer or a self-adhesive label;
(b) a modifying resin layer; and
(c) a chiral liquid crystal polymer (CLCP) layer, the modifying resin layer being able to change the position of the selective reflection band exhibited by the CLCP layer, and
an optional separate layer, when present, being located between the layer comprising a label stock layer or a self-adhesive label and the modifying resin layer and/or the modifying resin layer and the CLCP layer; and
a distribution of flakes being present in (i) the modifying resin layer and/or (ii) the separate layer; and the flakes being the same or different.

2. An auto-adhesive marking member according to claim 1, wherein the distribution of flakes is present in the modifying resin layer.

3. The auto-adhesive marking member according to claim 1, wherein a separate layer is present and the distribution of flakes is at least present in the separate layer.

4. The auto-adhesive marking member according to claim 3, wherein the separate layer is located between the layer comprising a label stock layer or a self-adhesive label and the modifying resin layer.

5. The auto-adhesive marking member according to claim 4, further including the distribution of flakes in the modifying resin layer.

6. The auto-adhesive marking member according to claim 5, wherein the distribution of flakes comprises the same flakes in the separate layer and the modifying resin layer.

7. The auto-adhesive marking member according to claim 5, wherein the distribution of flakes comprises different sizes of flakes in the separate layer and the modifying resin layer.

8. The auto-adhesive marking member according to claim 5, wherein the distribution of flakes comprises flakes having different detectable properties in the separate layer and the modifying resin layer.

9. A marking of a substrate, comprising a code; a distribution of flakes, the flakes being the same or different; and a self-adhesive label; the distribution of flakes being at least one of (i) between the code and the self-adhesive label, (ii) a layer of the self-adhesive label; and (iii) above the self adhesive-label.

10. The marking according to claim 8 wherein the code is selected from mono-dimensional and/or bidimensional code.

11. The marking according to claim 10, wherein the self-adhesive label is between the mono-dimensional and/or bidimensional code and the distribution of flakes.

12. The marking according to claim 11, further including a modifying resin layer above the distribution of flakes, a chiral liquid crystal polymer (CLCP) layer above the modifying resin layer, and the modifying resin layer being able to change the position of the selective reflection band exhibited by the CLCP layer.

13. The marking according to claim 12, wherein the distribution of flakes and the self-adhesive label are adjacent layers.

14. The marking according to claim 10, wherein the self-adhesive label is above the distribution of flakes.

15. The marking according to claim 14, wherein the distribution of flakes and the self-adhesive label are adjacent layers.

16. The marking according to claim 12, wherein the distribution of flakes and the self-adhesive label are adjacent layers.

17. The marking according to claim 10, wherein the distribution of flakes comprises a layer of the self-adhesive label.

18. The marking according to claim 10, wherein there at least two distributions of flakes layers, one of the two distributions of flakes layers being between the mono-dimensional and/or bidimensional code and the self-adhesive label and the other of the two distributions of flakers being above the self-adhesive label.

19. The marking according to claim 18, wherein the at least two distribution flakes layers also comprise a layer of the self-adhesive label.

20. The marking according to claim 10, wherein the code further comprises invisible to the unaided eyes a layer with secure and/or authentication and/or track and trace properties, glyph, encoded data invisible to the unaided eyes, watermark data, encrypted data with private and/or public Key, taggant and/or dyes and/or pigments which have luminescent and/or magnetic properties invisible to the unaided eye.

21. The marking according to claim 10, wherein at least part of the flakes are chiral liquid crystal polymer (CLCP) flakes having at least one layer of CLCP.

22. The marking according to claim 21, wherein the CLCP flakes further comprise an additional layer made with luminescent and/or magnetic material.

23. The marking according to claim 21, wherein the CLCP flakes are visible and/or invisible to the unaided eyes.

24. The marking according to claim 21, wherein the distribution of flakes comprises at least two different sizes of flakes and/or two different aspect ratios of flakes.

25. The marking according to claim 21, wherein the position of a selective reflection band exhibited by said flakes is the same or different.

26. The marking according to any claim 21, wherein the position of a selective reflection band exhibited by said flakes is comprised between 400 to 1200 nm.

27. The marking according to claim 10 in which the flakes are distributed randomly.

28. (canceled)

29. The marking according to claim 10, wherein said flakes at least partially overlapping said mono-dimensional and/or bidimensional code are dispersed in a binder.

30. The marking according to claim 29, wherein the binder is a resin which is able to change the position of the selective reflection band exhibited by a chiral liquid crystal polymer layer.

31. The marking according to claim 10, wherein said marking is affixed directly on the substrate.

32-38. (canceled)

39. Item or good containing a marking according to claim 10, wherein the item or good is the substrate of the marking and is selected from a seal, a capsule or a cork, packaging, a cartridge, a container that contains nutraceuticals, pharmaceuticals, foodstuffs or beverages, a banknote, a credit card, a stamp, a tax label, a security document, a passport, an identity card, a driver's license, an access card, a transportation ticket, an event ticket, a voucher, an ink-transfer film, a reflective film, an aluminum foil, a cigarette packaging and a commercial good.

40. (canceled)

41. A method of providing a marking on a substrate, wherein the method comprises:
printing or applying onto a surface of a substrate, a code;
applying onto at least a part of the code, one or more distribution of flakes layers and an auto-adhesive label; and
the relationship of the one or more distribution of flakes layers and the auto-adhesive label being such that the one or more distribution of flakes layers comprises one or more of (i) a distribution of flakes layer between the code and the auto-adhesive label, (ii) a distribution of flakes in the auto-adhesive label, and (iii) a distribution of flakes above the auto-adhesive label.

42. (canceled)

43. An item or good comprising a marking that is obtained by the method of claim 41.

44-48. (canceled)
